(19) United States
(12) Patent Application Publication
(10) Pub. No.: US 2013/0208795 A1
(43) Pub. Date: Aug. 15, 2013

(54) ENCODING MOTION VECTORS FOR VIDEO COMPRESSION

(71) Applicants: Yaowu Xu, San Diego, CA (US); Paul Gordon Wilkins, Cambridge (GB); Jim Bankoski, Los Gatos, CA (US)

(72) Inventors: Yaowu Xu, San Diego, CA (US); Paul Gordon Wilkins, Cambridge (GB); Jim Bankoski, Los Gatos, CA (US)

(73) Assignee: GOOGLE INC., Mountain View, CA (US)

(21) Appl. No.: 13/369,827

(22) Filed: Feb. 9, 2012

(51) Int. Cl. H04N 7/28

(52) U.S. Cl. 375/240.16; 375/E07.104; 375/E07.243

(57) ABSTRACT

Techniques for efficient coding of video content are presented. When encoding motion vectors of a current block of a current video frame, a coder management component analyzes encoded blocks of the current frame adjacent to the current block and encoded blocks of the previous video frame that occupy locations in the previous frame corresponding to the locations of the current block and blocks adjacent to the current block. The coder management component arranges motion vectors in order as a function of spatial proximity, temporal distance between the previous frame and the current frame, and/or motion vector magnitude. The coder management component selects a coding mode, based on the order, to transmit to the decoder. A coder component encodes the current block using the motion vector associated with the coding mode.

### TECHNICAL FIELD

This disclosure relates generally to video processing, and more specifically to encoding motion vectors for video compression.

### BACKGROUND

The amount of data representing media information, such as a still image and video image, can be extremely large. Further, transmitting digital video information over communication networks can consume large amounts of bandwidth. The cost of transmitting data from one location to another can be a function of number of bits transmitted per second. Typically, higher bit transfer rates are associated with increased cost. Higher bit rates also can progressively add to required storage capacities of memory systems, which can thereby increase storage cost. Thus, at a given quality level, it can be much more cost effective to use fewer bits, as opposed to more bits, to store digital images and videos. It therefore can be desirable to compress media data for recording, transmitting, or storing.

For a typical compression scheme, achieving higher media quality can require that more bits be used, which can, in turn, increase cost of transmission and/or storage. While lower bandwidth traffic may be desired so may higher quality media.

An encoder is a device capable of encoding (e.g., coding), and sometimes also decoding, digital media data. A decoder is a device capable of decoding digital media data. A codec is a device capable of coding and/or decoding digital media data. The term codec is derived from a combination of the terms code and decode, or the terms compress and decompress. A variety of codecs are commercially available. Codec classifications can include, for example, discrete cosine transfer codecs, fractal codecs, and wavelet codecs. An encoder or codec, by encoding the digital media data, can reduce the number of bits required to transmit signals, which can thereby reduce associated transmission costs.

Certain video compression schemes can use a technique known as motion compensation as part of the encoding process to facilitate encoding video content. In many cases, consecutive video frames in a sequence of video frames can have similar content at different locations within the image frames due to the movement of an object(s) from one video frame to the next. Motion compensation techniques can take advantage of content similarities between consecutive video frames to more efficiently encode a video frame. For instance, an encoder, employing a region (block) based motion compensation technique, can use one block of a reconstructed previous video frame as a reference (e.g., predictor block) when encoding one block of a current video frame. The encoder can generate a motion vector for the block in the current video frame to indicate the location of the block in the reconstructed previous video frame that can be used as a predictor block for the block in current frame. The encoder can then subtract the predictor block from the block in current video frame to form a residue block, and can code the residue block and the motion vector, rather than the original block of the current frame. This can thereby make the encoding process and decoding process more efficient.

For video compression schemes that use motion compensation, the bits used to encode motion vectors can make up a significant portion of compressed data. Therefore improving the efficiency of motion vector encoding can be desirable to improve the overall efficiency of video compression.

When encoding a block of a video frame, in some instances, certain conventional video codecs can reuse motion vectors associated with other blocks within the same video frame that already have been encoded. However, such conventional codecs may not reuse motion vectors in an efficient way and/or may not identify the most efficient motion vectors to reuse when encoding a block. As a result, conventional encoding techniques may use an undesirable amount of bits (e.g., may use more bits than necessary) to encode a block, which can undesirably increase the costs of transmission and/or storage of the video. Further, video quality may be undesirably (e.g., negatively) affected.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

Systems and methods disclosed herein relate to encoding video. Disclosed herein is a system that encodes video frames. The system includes a coder management component configured to arrange a subset of prior encoded motion vectors associated with prior encoded blocks of a first subset of prior encoded blocks of a current video frame and a second subset of prior encoded blocks of a previous video frame in a motion vector order, based at least in part on respective effective distances of the respective motion vectors of the subset of motion vectors in relation to a current block of the current video frame. The coder management component is further configured to select a coding mode and a prior encoded motion vector of the subset of prior encoded motion vectors included in the motion vector order, based at least in part on the motion vector order. The current video frame and the previous video frame are part of a sequence of video frames. The system also includes a coder component configured to encode the current block using the prior encoded motion vector directly to generate an encoded current block

Also disclosed herein is a method for encoding video frame. The method includes employing at least one processor to facilitate execution of code instructions retained in at least one memory device. The at least one processor, in response to execution of the code instructions, performs acts comprising: arranging respective prior encoded motion vectors associated with prior encoded blocks of a first subset of prior encoded blocks of a current video frame and a second subset of prior encoded blocks of a previous video frame in a specified order, based at least in part on respective effective distances of the respective prior encoded motion vectors in relation to a current block in the current video frame, wherein the current video frame and the previous video frame are part of a sequence of video frames; selecting a prior encoded motion vector from a subset of the respective prior encoded motion vectors, based at least in part on the specified order; and selecting a coding mode based at least in part on position of the prior encoded motion vector in the specified order.

Further disclosed herein is a system that encodes video frames. The system includes means for arranging respective prior encoded motion vectors associated with prior encoded blocks of a first subset of prior encoded blocks of a current video frame and a second subset of prior encoded blocks of a previous video frame in a specified order, based at least in part on respective effective distances of the respective prior encoded motion vectors in relation to a current block in the current video frame, wherein the current video frame and the previous video frame are part of a sequence of video frames. The system also contains means for identifying a prior encoded motion vector from the respective prior encoded motion vectors associated with the specified order, based at least in part on the specified order. The system further includes means for identifying a coding mode based at least in part on rank of the prior encoded motion vector in the specified order. The system also includes means for encoding the current block using the prior encoded motion vector to generate an encoded current block. The system further contains means for transmitting the encoded current block and the coding mode to a destination without transmitting a separate motion vector in relation to transmitting the encoded current block.

Also disclosed herein is a system that decodes video frames. The system includes a decoder management component configured to arrange respective motion vectors associated with respective prior decoded blocks of a first subset of prior decoded blocks of a current video frame and a second subset of prior decoded blocks of a previous video frame in a motion vector order based at least in part on respective effective distances of the respective motion vectors in relation to a current block in the current video frame, wherein the current video frame and the previous video frame are part of a sequence of video frames. The decoder management component is further configured to identify a coding mode associated with the current block, wherein the coding mode is received with the sequence of video frames. The decoder management component is further configured to select a motion vector from the respective motion vectors, based at least in part on the motion vector order and the coding mode. The system also includes a decoder component configured to decode the current block using the motion vector to generate a decoded current block.

The following description and the annexed drawings set forth in detail certain illustrative aspects of this disclosure. These aspects are indicative, however, of but a few of the various ways in which the principles of this disclosure may be employed. This disclosure is intended to include all such aspects and their equivalents. Other advantages and distinctive features of this disclosure will become apparent from the following detailed description of this disclosure when considered in conjunction with the drawings.

### BRIEF DESCRIPTION OF THE DRAWINGS

FIG. 1 illustrates a block diagram of an example system that can reuse motion vectors to facilitate efficiently encoding a video frame of a video frame sequence in accordance with various aspects and implementations described herein.

FIG. 2 depicts a diagram of example video frames of a video frame sequence, in accordance with various aspects and implementations.

FIG. 3 depicts a block diagram of an example system that can reuse motion vectors to facilitate efficiently decoding a video frame of a video frame sequence in accordance with various aspects and implementations described herein.

FIG. 4 illustrates a block diagram of an example encoder component in accordance with various aspects and implementations of this disclosure.

FIG. 5 presents a block diagram of an example decoder component in accordance with various aspects and implementations of this disclosure.

FIG. 6 depicts a flow chart of an example method for efficiently encoding a current block of a raw video frame of a video frame sequence, in accordance with various aspects and implementations.

FIG. 7 depicts a flow chart of another example method for efficiently encoding a current block of a raw video frame of a video frame sequence, in accordance with various aspects and implementations.

FIG. 8 illustrates a flow chart of an example method for efficiently decoding a current encoded block of a video frame of a video frame sequence, in accordance with various aspects and implementations.

FIG. 9 is a schematic block diagram illustrating a suitable operating environment.

FIG. 10 is a schematic block diagram of a sample-computing environment.

### DETAILED DESCRIPTION

Various aspects of this disclosure are now described with reference to the drawings, wherein like reference numerals are used to refer to like elements throughout. In the following description, for purposes of explanation, numerous specific details are set forth in order to provide a thorough understanding of one or more aspects. It should be understood, however, that certain aspects of this disclosure may be practiced without these specific details, or with other methods, components, materials, etc. In other instances, well-known structures and devices are shown in block diagram form to facilitate describing one or more aspects.

The amount of data representing media information can be extremely large. Further, transmitting digital video information over communication networks can consume large amounts of bandwidth. The cost of transmitting data from one location to another can be a function of number of bits transmitted per second. Typically, higher bit transfer rates are associated with increased cost. Higher bit rates also can progressively add to required storage capacities of memory systems, which can thereby increase storage cost. Thus, at a given quality level, it can be much more cost effective to use fewer bits, as opposed to more bits, to store digital images and videos. It therefore can be desirable to compress media data for recording, transmitting, or storing.

An encoder is a device capable of encoding (e.g., coding) (and sometimes decoding) digital media data. Encoding digital media data can involve compressing the digital media data, and decoding of encoded digital media data can involve decompressing the encoded digital media data.

Certain video compression schemes can use a technique known as motion compensation as part of the encoding process to facilitate encoding video content. An encoder, employing a region (block) based motion compensation technique, can use one block of a reconstructed previous video frame as a reference (e.g., predictor block) when encoding one block of a current video frame. The encoder can generate a motion vector for the block in the current video frame to indicate the location of the block in the reconstructed previous video frame, which can be a reconstructed video frame that can be used as a predictor block for the block in the current frame. The encoder can subtract the predictor block from the block in the current frame to form a residue block, and then code the residue block and the motion vector, instead of coding the original block of the current frame. This can thereby make the encoding process and decoding process more efficient.

For video compression schemes that use motion compensation, the bits used to encode motion vectors can make up a significant portion of compressed data. Therefore improving the efficiency of motion vector encoding can be desirable to improve the overall efficiency of video compression.

When encoding a block of a video frame, in some instances, certain conventional video codecs can reuse motion vectors associated with other blocks within the same video frame that already have been encoded and surround the block being encoded. However, such conventional codecs may not reuse motion vectors in an efficient way and/or may not identify the most efficient motion vectors to reuse when encoding a block. As a result, conventional encoding techniques may use an undesirable number of bits (e.g., may use more bits than necessary) to encode a block, which can undesirably increase the costs of transmission and storage of the video. Further, video quality may be undesirably (e.g., negatively) affected.

To that end, techniques for efficient coding of video content are presented. A coder component can encode video content, including encoding blocks of a current video frame of a video frame sequence to generate an encoded video frame. The coder component can be associated with (e.g., communicatively connected to) a coder management component that can control encoding of the video content. When encoding a current block of a current video frame, the coder management component can analyze prior encoded blocks of the current video frame that are adjacent to (e.g., next to, in proximity to, neighboring, surrounding, or contiguously surrounding) the current block. The coder management component also can analyze prior encoded blocks of the previous video frame(s) that occupy locations in the previous video frame(s) that can correspond to respective locations of the current block and blocks that are adjacent to the current block in the current video frame.

As part of the analysis, the coder management component can identify or determine (e.g., calculate, measure) respective effective distances of motion vectors of prior encoded blocks of the current and previous video frames that are under consideration. The coder management component can identify or determine an effective distance of a motion vector of a prior encoded block in relation to the current block as a function of spatial distance, temporal distance, and/or motion-vector magnitude, of the motion vector and associated prior encoded block in relation to the current block.

Regarding a prior encoded block of the current video frame, the coder management component can identify or determine (e.g., calculate, measure) respective effective distances between the motion vectors associated with the prior encoded blocks (e.g., adjacent blocks) of the current video frame in relation to the current block, as a function of the respective spatial distances between the prior encoded blocks associated with these motion vectors in relation to the current block. With regard to a motion vector associated with a prior encoded block of the current video frame, since the prior encoded block is in the current video frame, the temporal distance can be 0, and the product of temporal distance and motion-vector magnitude also can be 0. As a result, for a motion vector associated with a prior encoded block of the current video frame, the coder management component can identify or determine (e.g., calculate, measure) the effective distance between the motion vector (and associated prior encoded block) and the current block as being the spatial distance between the prior encoded block associated with the motion vector and the current block.

The coder management component also can identify or determine respective effective distances of desired motion vectors associated with prior encoded blocks of a previous video frame(s) in relation to the current block. For each motion vector associated with a prior encoded block, the coder management component can determine an effective distance of a motion vector associated with a prior encoded block in relation to the current block as a function of spatial distance, temporal distance, and motion-vector magnitude, of the motion vector associated with the prior encoded block in relation to the current block.

The coder management component can identify or determine (e.g., calculate) the spatial distance for the motion vector as the physical distance of the prior encoded block associated with the motion vector to the corresponding location in the previous video frame that corresponds to the location of the current block in the current video frame. The coder management component can identify or determine (e.g., calculate, measure) the temporal distance for the motion vector as a function of the length of time between the previous video frame associated with the motion vector under consideration and the current video frame. For example, the coder management component can determine that the temporal distance is 1 frame length worth of time when the prior encoded block and associated motion vector are in the video frame that immediately precedes the current video frame in the video frame sequence. The coder management component can determine that the temporal distance is 2 frame lengths worth of time when the prior encoded block and associated motion vector are in the video frame that precedes the current video frame by 2 frames in the video frame sequence. For each motion vector associated with a prior encoded block of a previous video frame(s), the coder management component also can identify the motion vector magnitude of the motion vector associated with the prior encoded block.

Based at least in part on the analysis results, the coder management component can arrange the motion vectors used for encoding these prior encoded blocks of the current and previous video frames in order from the motion vector (and associated prior encoded block) that is nearest in effective distance in relation to the current block to the motion vector (and associated prior encoded block) that is the furthest in effective distance in relation to the current block. In some implementations, the coder management component can identify a nearest motion vector (e.g., a first or nearest non-zero motion vector) and a near motion vector (e.g., a second or second-nearest non-zero motion vector that is a second closest motion vector) in relation to the current block based at least in part on the arranged order of the motion vectors. The nearest motion vector can be a non-zero motion vector that is nearest in effective distance to the current block, and the near motion vector can be a non-zero motion vector that is second closest in effective distance to the current block. In other implementations, as desired, the coder management component can consider and identify other motion vectors in addition to the nearest motion vector and near motion vector, in accordance with defined encoding criterion. For example, the coder management component can identify a defined number (e.g., 1, 2, 3, 4, 5, etc.) of motion vectors (e.g., non-zero motion vectors) that are most near in effective distance to the current block as compared to other motion vectors. For reasons of brevity and clarity, aspects of this disclosure generally will be described with regard to a nearest motion vector and a near motion vector.

As a further part of the analysis, the coder management component can determine whether either the nearest motion vector or the near motion vector can be used (e.g., reused) directly to encode the current block), in accordance with defined encoding criterion. If one of the nearest motion vector or near motion vector is selected, during encoding, the coder component can use the selected motion vector to generate a predictor block and correspondingly a residue block for the current block to facilitate encoding the current block. If the coder management component determines that at least one of the nearest motion vector or near motion vector can be used directly to encode the current block, the coder management component can identify or determine whether the current block will be encoded most efficiently using the nearest motion vector or the near motion vector. For example, the coder management component can identify and select which of the nearest motion vector or the near motion vector would use the least amount of bits to encode the current block in relation to each other. Additionally or alternatively, the coder management component can identify and select which of the nearest motion vector or the near motion vector is more efficient for encoding the current block based at least in part on a metric(s) that can account for both the bit rate and the distortion of the current block when encoding with either of the nearest or near motion vectors.

The coder management component can select the nearest motion vector or the near motion vector for use in encoding the current block, based at least in part on the analysis results. If the coder management component determines the current block will be encoded most efficiently using the nearest motion vector, the coder management component can select the nearest motion vector for encoding the current block. In these instances, the coder management component can select a coding mode (e.g., nearest-motion-vector coding mode) associated with the nearest motion vector. If the coder management component determines the current block will be encoded most efficiently using the near motion vector, the coder management component can select the near motion vector for encoding the current block. In such instances, the coder management component can select a coding mode (e.g., near-motion-vector coding mode) associated with the near motion vector.

The coder component can encode the current block using (e.g., reusing) the selected motion vector associated with the selected coding mode (e.g., the coder component can use the selected motion vector to generate a predictor block and correspondingly a residue block for the current block to facilitate encoding the current block). The coder management component can transmit the selected coding mode to a decoder component in relation to transmission of the encoded current block. As a result, the encoder component (and decoder component) can reuse the selected motion vector from a prior encoded block in relation to encoding the current block, and therefore the encoder component can avoid transmitting a separate or new motion vector in relation to the current block. This can thereby reduce the amount of bits used to encode the current block, which can reduce the amount of bandwidth and/or storage used in relation to the video frame sequence.

The decoder component can receive the encoded video bitstream, comprising the encoded current video frame and encoded previous video frame, in addition to other encoded video frames of the video frame sequence. The decoder component also can receive respective coding modes associated with respective blocks of encoded video frames of the video frame sequence for blocks where motion vectors used for encoding prior encoded blocks may have been reused.

The decoder component can include a decoder management component that can control decoding of the encoded video bitstream (e.g., encoded video frames of the video frame sequence). When decoding a current block of a current video frame, the decoder management component can analyze prior decoded blocks of the current video frame that are adjacent to the current block. The decoder management component also can analyze prior decoded blocks of the previous video frame(s) that occupy locations in the previous video frame(s) that can correspond to respective locations of the current block and blocks that are adjacent to the current block in the current video frame.

As part of the analysis, the decoder management component can identify or determine (e.g., calculate, measure) respective effective distances of motion vectors of prior decoded blocks of the current and previous video frames that are under consideration, in accordance with defined decoding criterion (e.g., which can correspond to the defined encoding criterion). The decoder management component can identify or determine an effective distance of a motion vector of a prior decoded block in relation to the current block as a function of spatial distance, temporal distance, and/or motion-vector magnitude, of the motion vector associated with a prior decoded block in relation to the current block. The decoder management component can identify or determine an effective distance of a motion vector of a prior decoded block in relation to a current block in a manner that can correspond to the manner in which the encoder management component can identify or determine an effective distance of a motion vector of a prior encoded block in relation to a current block.

Based at least in part on the analysis results and defined decoding criterion, the decoder management component can arrange in a desired order motion vectors used for decoding these prior decoded blocks of the current video frame and motion vectors used for decoding prior decoded blocks of the previous decoded video frame(s). For instance, the order can be from a motion vector (associated with a prior decoded block) nearest in effective distance in relation to the current block to a motion vector (associated with a prior decoded block) that is furthest in effective distance in relation to the current block. This motion vector ordering performed by the decoder management component on the decoder side can correspond to the motion vector ordering performed by the coder management component on the encoder side.

When arranging the motion vectors used for decoding prior decoded blocks of the current video frame, the decoder management component can arrange the motion vectors used for decoding the prior decoded blocks of the current video frame that that are adjacent to the current block, based at least in part on the spatial distance of the respective prior decoded blocks (associated with respective motion vectors) in relation to the current block. With regard to a motion vector associated with a prior decoded block in the current video frame, the spatial distance between the prior decoded block and the current block can be the effective distance.

When arranging the relevant motion vectors used for decoding prior decoded blocks of a previous video frame(s), the decoder management component can arrange these motion vectors based at least in part on respective effective distances of the motion vectors associated with the prior decoded blocks in relation to the current block. The decoder management component can determine the effective distance between a current block and a motion vector (associated with a prior decoded block) as a function of spatial distance between the prior decoded block and the current block, temporal distance between the previous video frame associated with the motion vector and the current video frame, and the motion-vector magnitude of the motion vector. The prior decoded blocks that can be considered can include the prior decoded blocks of the previous video frame(s) that occupy locations in the previous video frame(s) that can correspond to respective locations of the current block and blocks adjacent to the current block in the current video frame.

The decoder management component can identify the nearest motion vector (e.g., a first or nearest non-zero motion vector) and the near motion vector (e.g., a second or second-nearest non-zero motion vector that is a second closest motion vector) in relation to the current block based at least in part on the arranged order of the motion vectors associated with (e.g., used for decoding) the blocks of the current and previous video frames. The decoder management component also can identify the coding mode associated with the current block. The decoder component can receive the coding mode with the coded video bitstream received from the encoder component. When a motion vector has been reused in relation to the current block, the coding mode can be, for example, the nearest-motion-vector coding mode or the near-motion-vector coding mode. Based at least in part on which coding mode is associated with the current block, the decoder management component can select the nearest motion vector or the near motion vector from the ordered motion vectors (e.g., ordered motion vectors used for decoding prior decoded blocks). The decoder component can reuse the selected motion vector associated with the selected coding mode to decode the current block.

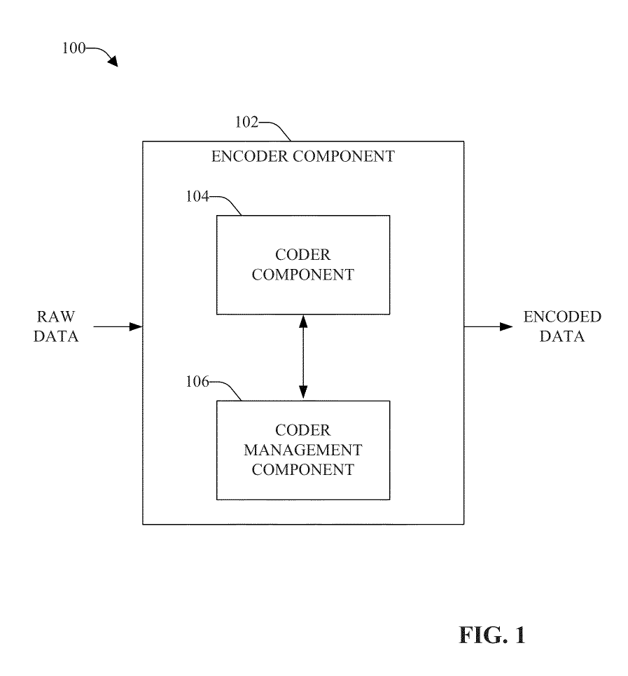

Referring now to the drawings, FIG. 1 illustrates a block diagram of an example system 100 that can reuse motion vectors to facilitate efficiently encoding a video frame of a video frame sequence in accordance with various aspects and implementations described herein. The system 100 can include an encoder component 102 that encodes received digital media data (e.g., digital video content, audio content, still image, multimedia content, etc.) to produce encoded digital media data as an output. The encoder component 102 can encode or compress the digital media data in accordance with a defined compression or encoding algorithm(s). The encoder component 102 can be a stand-alone unit, part of a codec, part of another component or unit, or can have portions of the encoder component 102 distributed in multiple components or units of the system 100.

In accordance with exemplary implementations, the encoder component 102 can control encoding of a current block of a current video frame (e.g., raw or partially encoded video frame) in part by reusing a desired prior encoded motion vector of a subset of prior encoded motion vectors when encoding the current block. The current block can be at row “r” and column “c” within the current video frame (e.g., current block (r, c) of current video frame f[i], wherein i can be a desired integer number). The subset of prior encoded motion vectors can be associated with a subset of prior encoded blocks of the current video frame (e.g., f[i]), a previous video frame (e.g., immediately previous video frame f[i−1], or other previous video frame (e.g., f[i−2], f[i−3], etc.). The subset of prior encoded blocks can include prior encoded blocks of the current video frame that are adjacent to (e.g., next to, in proximity to, neighboring, surrounding, or contiguously surrounding) the current block in the current video frame (e.g., block (r−1, c−1), block (r−1, c), block (r−1, c+1), etc., of current video frame f[i]). The subset of prior encoded blocks also can include prior encoded blocks of the previous video frame that occupy locations in the previous video frame that can correspond to respective locations of the current block and blocks adjacent to the current block in the current video frame (e.g., block (r, c), block (r−1, c−1), block (r−1, c), block (r−1, c+1), etc., of previous video frame f[i−1]).

The encoder component 102 can include a coder component 104 that can encode video content, including encoding blocks of a current video frame of a video frame sequence to generate an encoded video frame. As part of the encoding process, the coder component 104 (or another component, such as an estimator component (not shown), associated therewith) can perform motion estimation to generate motion vectors that can be used in motion compensation to facilitate encoding blocks of the video frame sequence.

Also, as part of the encoding process, the coder component 104 can encode motion vectors and/or reuse prior encoded motion vectors to encode video frames (e.g., the current video frame) of the video frame sequence, based at least in part on defined encoding criterion (e.g., predefined encoding criterion, or encoding criterion identified and/or implemented in real time). The defined encoding criterion can relate to, for example, the spatial distances between a current block and prior encoded blocks in the current video frame that are adjacent to the current block, and/or the combination of the respective spatial distances of respective prior encoded blocks of a previous video frame in relation to the current block and respective motion-vector magnitudes of the prior encoded blocks of the previous video frame. In some implementations, the defined encoding criterion can relate to the combination of respective spatial distances of respective prior encoded blocks of a previous video frame in relation to the current block, respective motion-vector magnitudes of motion vectors associated with the prior encoded blocks of the previous video frame, and the temporal distance between the previous video frame and the current video frame. For example, the temporal distance between video frame f[i] and video frame f[i−1] can be 1-frame worth of time, the temporal distance between f[i] and f[i−2] can be 2-frames worth of time, etc. The defined encoding criterion also can relate to a first (e.g., nearest) motion vector, a second (e.g., near) motion vector, other defined motion vector (e.g., 3^{rd} nearest, 4^{th} nearest, etc.), whether a motion vector is a non-zero motion vector, etc. The defined encoding criterion further can relate to encoding efficiency of one defined motion vector (e.g., nearest motion vector) in relation to another defined motion vector(s) (e.g., near motion vector), number of bits and/or amount of time (e.g., expected) to be used to encode the current block (e.g., directly), the encoding error, a predicted new motion vector, etc. The encoding error can be calculated, for example, as a function of differences between reconstructed pixel values of the encoded current block and raw pixel values of the current block.

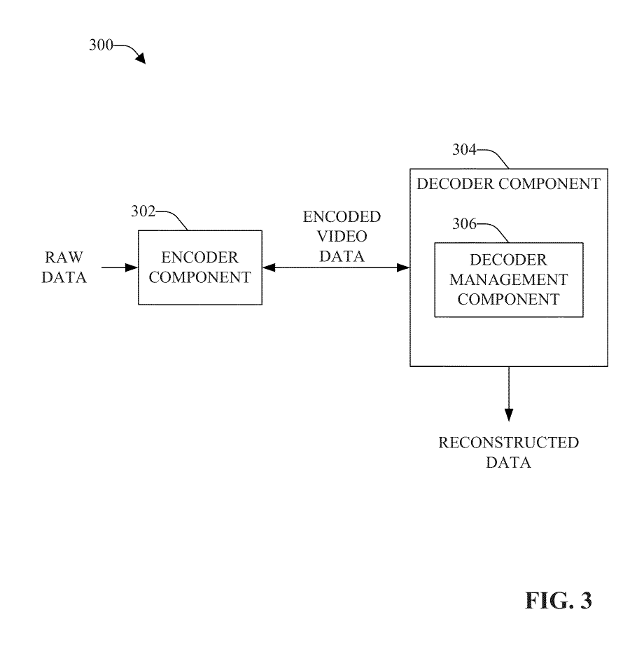

In some implementations, the encoder component 102 can reuse a motion vector (e.g., prior encoded motion vector) associated with a prior encoded block (e.g., of the current video frame or previous video frame) to encode a current block of the current video frame, in accordance with the defined encoding criterion. As more fully disclosed herein, the encoder component 102 can select a coding mode associated with the reused prior encoded motion vector, and can transmit the coding mode with the encoded current block to a decoder component (not shown in FIG. 1; as depicted in FIG. 3). The coding mode can facilitate enabling the decoder component to identify an appropriate motion vector to reuse to decode the current block at the decoder side. As a result, in such instances, since the motion vector used to encode the current block also was used in relation to a prior encoded block, the encoder component 102 can avoid transmitting a separate or new motion vector to the decoder component in relation to the current block. The encoder component 102, by employing the encoding techniques described in this disclosure, can thereby reduce the number of bits used to encode the video frame sequence, the number of bits transmitted and consequently the amount of bandwidth used in relation to transmission of the video frame sequence, and/or the amount of storage space used to store the encoded video frame sequence, as compared to conventional encoding techniques.

The encoder component 102 can include a coder management component 106 that can be associated with (e.g., communicatively connected to) the coder component 104. The coder management component 106 can control encoding of the video frame sequence (e.g., video content). When the encoder component 102 is searching for a motion vector for encoding a current block of a current video frame of the sequence, the coder management component 106 can analyze prior encoded blocks of the current video frame that are adjacent to the current block. The coder management component 106 also can analyze prior encoded blocks of a previous video frame(s) (e.g., video frame f[i−1], video frame f[i−2], and/or video frame f[i−3], etc.) that occupy locations in the previous video frame(s) that can correspond to respective locations of the current block and blocks adjacent to the current block in the current video frame.

As part of the analysis, for each prior encoded block under consideration, the coder management component 106 can identify or determine (e.g., calculate, measure) the spatial distance between the prior encoded block (associated with the prior encoded motion vector) and the current block. For each prior encoded block of the previous video frame(s) under consideration (e.g., blocks of the previous video frame corresponding to blocks adjacent to the block to be coded), the coder management component 106 also can identify or determine (e.g., calculate, measure) the magnitude of the motion vector associated with the prior encoded block. For each prior encoded block of the previous video frame under consideration, the coder management component 106 also can identify or determine (e.g., calculate, measure) the temporal distance between the previous video frame and the current video frame (e.g., the temporal distance between f[i] and f[i−1] can be 1-frame worth of time, the temporal distance between f[i] and f[i−2] can be 2-frames worth of time). The “adjacent” blocks of a previous video frame can include prior encoded blocks that are located in positions in the previous video frame that correspond to positions of blocks that are adjacent to the current block in the current video frame and the prior encoded block located in a position in the previous video frame that corresponds to the position of the current block in the current video frame. The coder management component 106 can determine an effective distance between the motion vector associated with a prior encoded block in relation to the current block as a function of the magnitude of the motion vector, temporal distance between the previous video frame of the prior encoded block and the current frame, and the spatial distance between the prior encoded block associated with the motion vector in relation to the current block.

In some implementations, the coder management component 106 can calculate the effective distance (ED) in accordance with the following example function (e.g., mathematical function): magnitude of (MV*TD+SDV). In the example function, MV can be a vector of the prior encoded motion vector, TD can be a temporal distance, and SDV can be a spatial distance vector between the prior encoded block associated with the motion vector and the current block. The temporal distance can be defined as the number of frames prior to the current video frame in the video frame sequence in which the previous video frame associated with the motion vector associated with the prior encoded block appears. For example, the previous video frame immediately preceding the current video frame in the sequence can have a temporal distance of one frame length worth of time. Further, in a 2-dimensional Cartesian coordinate system, a motion vector or a spatial distance vector can have two components (e.g., row and column, or x and y). When such a Cartesian coordinate system is used, some implementations can calculate the effective distance in accordance with the following example equation: ED=sqrt((MVM1*TD+SD1)²+(MVM2*TD+SD2)²). In this example equation, MVM1 and MVM2 can be the first and the second motion vector components of motion vector MV, and SD1 and SD2 can be the first and second distance components of the spatial distance vector SDV respectively, TD is temporal distance, and sqrt means square root.

In still other implementations, the coder management component 106 can apply respective weighting factors relating to spatial distance, motion-vector magnitude, or other parameters, and/or can apply respective functions (e.g., mathematical or probabilistic functions) based at least in part on the position of the relevant video frame in relation to the current video frame (e.g., temporal distance). For example, the coder management component 106 can use a first subset of weighting factors and/or a first function in relation to prior encoded blocks (and associated prior encoded motion vectors) of a first previous video frame (e.g., f[i−1]) in relation to the current video frame. The coder management component 106 can use a second subset of weighting factors and/or a second function in relation to prior encoded blocks (and associated prior encoded motion vectors) of a second previous video frame (e.g., f[i−2]) in relation to the current video frame.

Based at least on the results of the analysis, the coder management component 106 can arrange the motion vectors used for encoding these prior encoded blocks of the current and previous video frames in order from the motion vector (associated with a prior encoded block) that is closest in effective distance to the current block to the motion vector (associated with a prior encoded block) that is furthest in effective distance away from the current block. The coder management component 106 can identify a nearest motion vector (e.g., a nearest non-zero motion vector) and a near motion vector (e.g., a non-zero motion vector that is a second closest motion vector) in relation to the current block based at least in part on the arranged order of the motion vectors.

In some implementations, as part of the analysis, the coder management component 106 can determine whether either of the nearest motion vector or the near motion vector can be used (e.g., reused) directly to encode the current block, in accordance with defined encoding criterion. The defined encoding criterion for such determination can relate to, for example, the number of bits to be used when encoding the current block directly using a particular (e.g., nearest or near) motion vector, and/or the encoding error associated with encoding the current block (e.g., a function of differences between reconstructed pixel values of the encoded current block and raw pixel values of the current block). The defined encoding criterion for such determination also can relate to the amount of time expected to be used when encoding the current block directly using a particular (e.g., nearest or near) motion vector. The defined encoding criterion for such determination further can relate to a predicted motion vector, encoding-related metrics (e.g., rate distortion, sum squared prediction error, sum absolute difference error score, etc.), motion compensation, etc., associated with encoding a current block.

For example, the coder management component 106 can evaluate encoding the current block using either of the nearest or near motion vector directly as compared to predicting a new motion vector based on blocks adjacent to the current block in the current video frame and coding the difference between the real motion vector and the predicted new motion vector for the current block. The coder management component 106 can apply defined encoding criterion (e.g., respective number of bits, the encoding error, and/or the respective amounts of time to be used to encode, etc.) in determining whether to encode the current block directly using the nearest or near motion vector, or to encode the current block using the predicted new motion vector and coding the difference between the real motion vector and predicted new motion vector. Based on the encoding criterion applied, the coder management component 106 can determine that the current block is to be encoded directly using the nearest or near motion vector, for instance, if doing so will use less bits, is expected to produce less encoding error, and/or is expected to take less time than encoding the current block using the predicted new motion vector and coding the difference between the real motion vector and predicted new motion vector. In accordance with defined encoding criterion, the coder management component 106 can apply respective weighting to respective encoding criterion, apply an encoding-related algorithm that can balance various encoding-related factors against each other, and/or apply respective threshold levels to respective encoding criterion, etc., to facilitate determining whether to encode the current block by directly using the nearest or near motion vector.

If the coder management component 106 determines that at least one of the nearest motion vector or near motion vector can be used directly to encode the current block, the coder management component 106 can identify or determine whether the current block will be encoded most efficiently using the nearest motion vector or the near motion vector. The coder management component 106 can select either the nearest motion vector or the near motion vector for use in encoding the current block based at least in part on the analysis results indicating which of these motion vectors will encode the current block most efficiently in accordance with the defined encoding criterion. If the coder management component 106 determines the current block will be encoded most efficiently using the nearest motion vector as compared to the near motion vector, the coder management component 106 can select the nearest motion vector for encoding the current block. Conversely, if the coder management component 106 determines the current block will be encoded most efficiently using the near motion vector as compared to the nearest motion vector, the coder management component 106 can select the near motion vector for encoding the current block.

For example, the coder management component 106 can apply the defined encoding criterion relating to number of bits, the encoding error, and/or amount of time used to encode. In accordance with the applicable encoding criterion, the coder management component 106 can determine which of the nearest motion vector and near motion vector will use the lowest number of bits, produce the least amount of encoding error, and/or take the least amount of time to encode the current block directly. The coder management component 106 can select the particular (e.g., either nearest or near) motion vector that will use the lowest number of bits, produce the least amount of encoding error, take the least amount of time to encode the current block directly, and/or contain the most desired balance of the combination of these factors (e.g., in accordance with an encoding-related algorithm).

The coder management component 106 also can select a coding mode corresponding to the selected motion vector. For example, the coder management component 106 can select the nearest-motion-vector coding mode when the nearest motion vector is selected, and can select the near-motion-vector coding mode when the near motion vector is selected.

The coder component 104 can encode the current block using (e.g., reusing) the prior encoded motion vector (e.g., nearest motion vector, near motion vector) associated with the selected coding mode. In some implementations, the coder component 104 can generate a predictor block using (e.g., reusing) the prior encoded motion vector. The coder component 104 can generate a residue block by subtracting the predictor block from the current block. The coder component 104 also can encode the residue block to generate an encoded residue block, which can be part of or associated with the encoded current block.

The coder management component 106 can facilitate transmitting the selected coding mode to the decoder component in relation to transmission of the encoded current block, which can be or can include the encoded residue block, in an encoded video bitstream. As a result, the encoder component 102 can reuse the selected prior encoded motion vector associated with the selected prior encoded block in relation to encoding the current block, and therefore avoid transmitting a separate or new motion vector in relation to the current block. This can reduce the number of bits used to encode the current block, reduce the number of bits used to transmit or store the current block, and/or reduce the amount of bandwidth and/or storage used in relation to transmitting or storing the current block and associated video frame sequence, and can improve overall encoding efficiency, as compared to conventional encoding systems and techniques.

In some implementations, the coder management component 106 can employ other coding modes (e.g., when a current block is being encoded without reusing a prior encoded motion vector). For example, when the motion vector associated with the current block is a zero motion vector, the coder management component 106 can select a zero-motion-vector mode in relation to encoding the current block. As another example, when the motion vector associated with the current block is a new motion vector, the coder management component 106 can select a new-motion-vector mode in relation to encoding the current block. As still another example, as desired, the coder management component 106 can use one or more other coding modes (e.g., coding mode for the 3^{rd} nearest motion vector, coding mode for the 4^{th} nearest motion vector, etc.) in addition to the nearest-motion-vector coding mode and the near-motion-vector coding mode.

Also, as desired, the coder management component 106 can employ other coding modes, such as left-motion-vector coding mode to refer to the motion vector associated with the prior encoded block to the left of the current block, right-motion-vector coding mode to refer to the motion vector associated with the prior encoded block to the right of the current block, etc. In some implementations, the coder management component 106 can identify a coding mode associated with a selected motion vector (e.g., prior encoded motion vector) by the position of the block associated with the motion vector in relation to the current block (e.g., left of the current block, right of the current block) and the video frame (e.g., current video frame, previous video frame) to which the motion vector belongs.

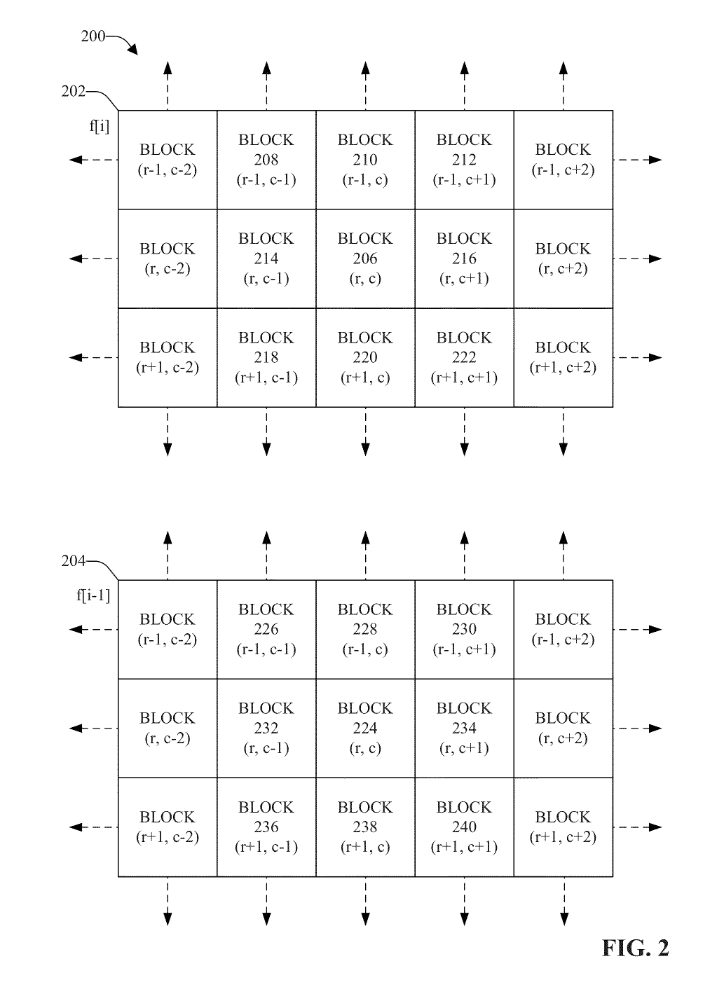

Referring to FIG. 2 (along with FIG. 1), FIG. 2 depicts a diagram of example video frames 200 (e.g., current video frame and previous video frame) of a video frame sequence, in accordance with various aspects and implementations. The example video frames 200 can include a current video frame 202 (e.g., J[i]) and a previous video frame 204 (e.g., f[i−1]) of the video frame sequence. The coder management component 106 (or coder component 104) can divide each video frame (e.g., 202, 204) into a plurality of blocks or partitions. Each of the video frames of the video frame sequence can include an array of pixels that can be used to provide (e.g., present, display) visual information (e.g., visual images) to users. The pixels can have a defined size, and can be positioned in respective locations in a video frame.

The coder management component 106 (or coder component 104) can divide the current video frame 202 to have a plurality of rows and a plurality of columns forming a plurality of blocks, including a current block 206 (e.g., (r, c)) and adjacent blocks 208 (e.g., (r−1, c−1)), 210 (e.g., (r−1, c)), 212 (e.g., (r−1, c+1)), 214 (e.g., (r, c−1)), 216 (e.g., (r, c+1)), 218 (e.g., (r+1, c−1)), 220 (e.g., (r+1, c)), and 222 (e.g., (r+1, c+1)). The coder management component 106 (or coder component 104) also can divide the previous video frame 204 to have a plurality of rows and a plurality of columns forming a plurality of blocks. The previous video frame 204 can include a block 224 (e.g., (r, c) of f[i−1]) that can correspond in location to the location of the current block 206 in the current video frame 202, and adjacent blocks 226 (e.g., (r−1, c−1)), 228 (e.g., (r−1, c)), 230 (e.g., (r−1, c+1)), 232 (e.g., (r, c−1)), 234 (e.g., (r, c+1)), 236 (e.g., (r+1, c−1)), 238 (e.g., (r+1, c)), and 240 (e.g., (r+1, c+1)). In accordance with various instances, depending on the point in the encoding process, a current block can be a block that is in a different part of the video frame, and the blocks that are considered adjacent blocks can be identified accordingly. While each of the current video frame 202 and previous video frame 204 are shown with 15 blocks, there can be more (or less) than 15 blocks, as desired, and the dotted arrowed lines in FIG. 2 are intended to illustrate that the rows and columns of blocks can extend beyond the 15 blocks shown (e.g., block (r−2, c−1), block (r−3, c−1), block (r−4, c−1), etc.; block (r+2, c−1), block (r+3, c−1), block (r+4, c−1), etc.).

The coder management component 106 can analyze prior encoded motion vectors associated with desired prior encoded blocks of the current video frame 202 and the previous video frame 204. For example, in the current video frame 202, block 208, block 210, and block 214 can be encoded prior to the current block 206 and can be blocks that are adjacent to (e.g., sometimes referred to herein as surrounding or contiguously surrounding) the current block 206 in relation to their respective positions within the current video frame 202. The coder management component 106 can analyze information relating to prior encoded blocks 208, 210 and 214 (e.g., information relating to spatial proximity of blocks 208, 210 and 214 in relation to the current block 206). In other implementations, the coder management component 106 can identify prior encoded blocks of the current video frame based at least in part on various other block orders of encoding. For example, if block 216, block 218, and/or block 220 are encoded prior to current block 206 based on a block order of encoding, the coder management component 106 can analyze block 216, block 218, and/or block 220 as prior encoded blocks of current video frame.

In the previous video frame 204, block 224 can be encoded prior to the current block 206 and can correspond to the location of the current block 206 in the current video frame 202. Also, block 226, block 228, block 230, block 232, block 234, block 236, block 238, and block 240 can be encoded prior to the current block 206 and can be blocks that are adjacent to block 224 in relation to location, and can thereby respectively correspond to locations in the current video frame 202 that are adjacent to the current block 206 in the current video frame 202. The coder management component 106 can analyze information relating to these prior encoded blocks 224 through 240. The information can relate to, for example, spatial proximity of these prior encoded blocks (and associated motion vectors) in relation to the current block 206, information relating to the motion-vector magnitudes of motion vectors associated with these prior encoded blocks, and/or temporal distance between the previous video frame 204 and the current video frame 202.

Based at least in part on the analysis, with regard to the current video frame 202, the coder management component 106 can identify or determine (e.g., calculate, measure) the respective effective distances between the motion vectors, which are respectively associated with the prior encoded blocks 208, 210 and 214, in relation to the current block 206. The coder management component 106 can determine the effective distance using the following example equation: ED=sqrt((MVM1*TD+SD1)²+(MVM2*TD+SD2)²), as more fully described herein. Since these prior encoded blocks 208, 210, and 214 are part of the current video frame 202, the effective distance for a motion vector can be equal to the spatial distance between the current block 206 and the prior encoded block (e.g., 208, 210 or 214) associated with that motion vector, because TD=0.

For example, the coder management component 106 can determine that block 208 is 8 pixels in the x-direction and 8 pixels in the y-direction away from the current block 206, and can thereby determine that the effective distance between the block 208 and current block 206 is the sqrt((0+8)²+(0+8)²) pixels=sqrt(128) pixels. The coder management component 106 also can determine that block 210 is 0 pixels in the x-direction and 8 pixels in the y-direction away from the current block 206, and can thereby determine that the effective distance between the block 210 and current block 206 is the sqrt((0+0)²+(0+8)²) pixels=8 pixels. The coder management component 106 further can determine that block 214 is 8 pixels in the x-direction and 0 pixels in the y-direction away from the current block 206, and can thereby determine that the effective distance between the block 210 and current block 206 is the sqrt((0+8)²+(0+0)²) pixels=8 pixels.

Also, based at least in part on the analysis, with regard to the previous video frame 204, the coder management component 106 can determine the effective distance of motion vectors of prior encoded blocks (e.g., 224 through 240) of the previous video frame 204 in relation to the current block 206 in the current video frame 202. The coder management component 106 can determine the effective distance of a motion vector associated with the prior encoded block as a function of the motion-vector magnitude of the motion vector, temporal distance between the previous video frame 204 and current video frame 202, and the spatial distance between the prior encoded block (associated with the motion vector) of the previous video frame 204 in relation to the current block 206. The coder management component 106 can determine (e.g., calculate, measure) the effective distance for a motion vector as: ED=sqrt((MVM1*TD+SD1)²+(MVM2*TD+SD2)²). Here, sqrt means square root, MVM1 can be a first motion vector component magnitude (e.g., associated with the row “r” or x-direction), SD1 can be a first spatial distance component (e.g., corresponding to a first direction associated with the row “r” or the x-direction) between the prior encoded block (e.g., of the previous video frame 204) and the current block 206. Also, MVM2 can be a second motion vector magnitude (e.g., associated with the column “c” or y-direction), and SD2 can be a second spatial distance (e.g., corresponding a second direction associated with the column “c” or y-direction) between the prior encoded block and the current block 206. TD can be a temporal distance measured in the number of frames from the previous video frame 204 to the current video frame 202 (e.g., the temporal distance between frame f[i] and frame f[i−1] can be 1 frame length worth of time, the temporal distance between frame f[i] and frame f[i−2] can be 2 frame lengths worth of time, and so on).

As a further part of the above example, the coder management component 106 can determine that block 224 is 0 pixels in the x-direction and 0 pixels in the y-direction away from the current block 206, and has a motion-vector magnitude of (3, 4) (e.g., motion-vector (my) (3, 4)) and can thereby determine that the effective distance between the block 210 and current block 206 is the sqrt((3*1+0)²+(4*1+0)²) pixels=5 pixels. The coder management component 106 also can determine that block 234 is 0 pixels in the x-direction and 8 pixels in the y-direction away from the current block 206, and has a motion-vector magnitude of (3, 3) (e.g., my (3, 3)) and can thereby determine that the effective distance between the block 210 and current block 206 is the sqrt((3*1+0)²+(3*1+8)²) pixels=sqrt(130) pixels. For reasons of brevity and clarity, the effective distances of other motion vectors of other “adjacent” prior encoded blocks (e.g., 226, 228, 230, . . . ) of the previous video frame 204 in relation to the current block 206 are not explicitly detailed here.

As a further part of the analysis, the coder management component 106 can sort and/or order motion vectors used for encoding the prior encoded blocks of the current video frame 202 and previous video frame 204. As a further part of the above example, in relation to the current block 206, the coder management component 106 can sort and/or order the motion vectors used for encoding the prior encoded blocks, block 208, block 210, block 214, block 224, and block 234, based at least in part on the respective effective distances of the respective motion vectors of prior encoded blocks in relation to the current block 206. In some implementations, in accordance with defined encoding criterion, the coder management component 106 can sort and/or order these motion vectors used for encoding the prior encoded blocks from closest effective distance to furthest effective distance in relation to the current block 206.

For instance, the coder management component 106 can sort and order these prior encoded motion vectors from closest effective distance to furthest effective distance in relation to the current block 206 as follows: (1) motion vector used for encoding block 224 at a distance of 5 pixels, (2) motion vector used for encoding block 214 at a distance of 8 pixels, (3) motion vector used for encoding block 210 at a distance of 8 pixels, (4) motion vector for encoding block 208 at a distance of sqrt(128) pixels, and (5) motion vector used for encoding block 234 at a distance of sqrt(130) pixels. For reasons of brevity and clarity, only the first 5 motion vectors in the possible list are described here. In various other implementations, the list of motion vectors can further include motion vectors used for encoding other prior encoded blocks of the current video frame 202 and previous video frames (e.g., 204).

In some implementations, when the respective effective distances of prior encoded motion vectors in relation to the current block are the same, the sorting and ordering of these prior encoded motion vectors in relation to each other, by the coder management component 106, can be based at least in part defined encoding criterion. The defined encoding criterion can relate to, for example, whether a prior encoded block (and associated motion vector) is in a current video frame or in a previous video frame, respective locations of the prior encoded motion vectors to the current block, or respective magnitudes of the prior encoded motion vectors. The defined encoding criterion also can relate to respective encoding parameters (e.g., quantization parameter used for the block, reference frame type, etc), or respective weighting of parameters (e.g., spatial distance, motion-vector magnitude, temporal distance, etc.) of respective prior encoded motion vectors or associated prior encoded blocks, etc.

For instance, in the above example, the coder management component 106 can identify the motion vector associated with block 210 and the motion vector associated with block 214 of the current video frame 202 as each being 8 pixels in effective distance from the current block 206. The coder management component 106 also can identify a motion-vector magnitude of mv(3, 6) associated with block 210 and a motion-vector magnitude of mv(3, 5) associated with block 214. The coder management component 106 further can identify the motion-vector magnitude of mv(3, 5) associated with block 214 as having a relatively lower magnitude than the motion-vector magnitude of mv(3, 6) associated with block 210. Based at least in part on defined encoding criterion, the coder management component 106 can arrange the order of motion vectors used for encoding these prior encoded blocks to place the motion vector associated with block 214 before the motion vector associated with block 210, due in part to the relatively lower motion-vector magnitude associated with block 214 in relation to the motion-vector magnitude associated with block 210. As a result, in the motion vector order, the coder management component 106 can identify the motion vector associated with block 214 as being nearer in effective distance to the current block 206 than the motion vector associated with block 210, even though their respective effective distances have the same nominal value.

To further continue with the above example, the coder management component 106 can identify the motion vector (e.g., mv(3, 4)) associated with block 224 as a nearest motion vector since it is the closest in effective distance (e.g., it is the first motion vector in the motion vector order) to the current block 206 relative to the other prior encoded motion vectors and it is a non-zero motion vector. The coder management component 106 also can identify the motion vector (e.g., mv(3, 5)) associated with block 214 as a near motion vector (e.g., second closest motion vector), in relation to the current block 206, since the motion vector associated with block 214 is the second closest in effective distance (e.g., second in the motion vector order) to the current block 206 relative to the other prior encoded motion vectors and it is a non-zero motion vector.

In certain implementations, the coder management component 106 can adjust the motion vector order based at least in part on how many times (e.g., frequency) a motion vector appears in the motion vector order, in accordance with defined encoding criterion. For example, if there are two prior encoded blocks that use exactly the same motion vector mv(3, 8), the motion vector mv(3, 8) appears in the motion vector order twice. In such instance, the coder management component 106 can adjust the motion vector order (e.g., adjust ranking of motion vectors in the order) by moving motion vector mv(3, 8) ahead of certain other motion vectors that appear only once in the motion vector order (e.g., even though that motion vector's effective distance in relation to the current block 206 is not as small as that of those certain other motion vectors). The coder management component 106 can determine the amount of adjustment in motion vector order based at least in part on applicable defined encoding criterion.

In some implementations, the coder management component 106 can determine whether either of the nearest motion vector or the near motion vector can be used (e.g., reused) directly to encode the current block 206, in accordance with defined encoding criterion. If the coder management component 106 determines that at least one of the nearest motion vector or near motion vector can be used directly to encode the current block, the coder management component 106 can identify or determine which of the nearest motion vector or the near motion vector will most efficiently encode the current block 206, in accordance with the defined encoding criterion.

If the coder management component 106 determines that using the nearest motion vector (e.g., mv(3, 4)) to encode the current block 206 will more efficiently encode the current block 206 than using the near motion vector (e.g., mv(3, 5)) to encode the current block 206, the coder management component 106 can select the nearest motion vector for encoding the current block 206. The coder component 104 can use (e.g., reuse) the nearest motion vector to encode the current block 206. The coder management component 106 also can select the coding mode associated with the nearest motion vector (e.g., nearest-motion-vector coding mode), and can transmit this coding mode with the encoded current block 206 to the desired destination (e.g., decoder component, data store, etc.).

If the coder management component 106 determines that using the near motion vector (e.g., mv(3, 5)) to encode the current block 206 will more efficiently encode the current block 206 than using the nearest motion vector (e.g., mv(3, 4)) to encode the current block 206, the coder management component 106 can select the near motion vector for encoding the current block 206. The coder component 104 can use (e.g., reuse) the near motion vector to encode the current block 206. The coder management component 106 can select the coding mode associated with the near motion vector (e.g., near-motion-vector coding mode), and can transmit this coding mode with the encoded current block 206 to the desired destination (e.g., decoder component, data store, etc.) in relation to the current block 206 (e.g., as part of the associated encoded video bitstream).

The coder management component 106 can already be transmitting (and/or storing) the selected prior encoded motion vector (e.g., the nearest motion vector or near motion vector) in relation to its associated block (e.g., block 224 or block 214, respectively) in the encoded video bitstream that is also associated with the current block 206. As a result, the coder management component 106 can avoid transmitting the selected prior encoded motion vector again in relation to the encoded current block 206, since the selected prior encoded motion vector can be reused (e.g., by a decoder component) to decode the encoded current block 206.

In accordance with various aspects, as more fully disclosed herein, the decoder component can receive the encoded video bitstream, and can identify the selected coding mode in the bitstream. The decoder component can begin to decode video frames of the video frame sequence. The decoder component can arrange prior decoded motion vectors of prior decoded blocks of a current video frame or a previous video frame in a desired block order based at least in part on respective effective distances of the prior decoded motion vectors in relation to a current block being decoded. The ordering of the prior decoded motion vectors can correspond to the motion vector ordering performed by the encoder component 102 when encoding the video frame sequence. The decoder component can identify the nearest motion vector and near motion vector based at least in part on the ordering of the prior decoded motion vectors (and associated prior decoded blocks). The decoder component also can identify the prior decoded motion vector (e.g., nearest motion vector or near motion vector) associated with the received coding mode relating to the encoded current block. The decoder component can use the identified prior decoded motion vector to facilitate decoding the encoded current block (e.g., corresponding to block 206).

FIG. 3 illustrates a block diagram of an example system 300 that can reuse motion vectors to facilitate efficiently decoding a video frame of a video frame sequence in accordance with various aspects and implementations described herein. The system 300 can include an encoder component 302 that can receive raw data, such as raw video frames of a video frame sequence, and can encode blocks of raw video frames to generate encoded video frames. In some implementations, to facilitate efficiently encoding a current block of a current video frame, the encoder component 302 can reuse a prior encoded motion vector of the current video frame or a previous video frame to encode the current block, in accordance with defined encoding criterion, as more fully disclosed herein.

The system 300 also can include decoder component 304 that can receive an encoded current video frame and encoded previous video frame(s), in addition to other encoded video frames of the video frame sequence. The decoder component 304 also can receive respective coding modes associated with respective blocks of encoded video frames of the video frame sequence. The decoder component 306 can include a decoder management component 306 that can control decoding of encoded video content (e.g., encoded video frames in the encoded video bitstream).

When decoding a current block of a current video frame, the decoder management component 306 can analyze information relating to prior decoded blocks of the current video frame that are adjacent to the current block. The decoder component 306 also can analyze information relating to prior decoded blocks of a previous video frame(s) that occupy locations in the previous video frame(s) that can correspond to respective locations of the current block and blocks adjacent to the current block in the current video frame. Based at least in part on the analysis results, the decoder management component 306 can arrange motion vectors associated with these prior decoded blocks of the current video frame and prior decoded blocks of the previous decoded video frame(s) in a desired order, in accordance with defined decoding criterion. The defined decoding criterion can correspond to the defined encoding criterion used to encode the current block and other blocks. In some implementations, the decoder management component 306 can order motion vectors associated with these prior decoded blocks from closest in effective distance in relation to the current block to furthest away in effective distance from the current block. This motion vector ordering performed by the decoder management component 306 on the decoder side can correspond to the motion vector ordering performed by the coder management component (e.g., 106) on the encoder side.

As part of the analysis, the decoder management component 306 can identify or determine (e.g., calculate, measure) respective effective distances of motion vectors of prior decoded blocks of the current and previous video frames that are under consideration, in accordance with defined decoding criterion. The decoder management component 306 can identify or determine an effective distance of a motion vector of a prior decoded block in relation to the current block as a function of spatial distance, temporal distance, and/or motion-vector magnitude, of the motion vector (and associated prior decoded block) in relation to the current block. In some implementations, the decoder management component 306 can determine the effective distance for a motion vector in relation to a current block using the following example equation: ED=magnitude of (MV*TD+SDV), as more fully described herein. In other implementations, with regard to a 2-dimensional Cartesian coordinate system, the decoder management component 306 can determine the effective distance for a motion vector in relation to a current block using this example equation: ED=sqrt((MVM1*TD+SD1)²+(MVM2*TD+SD2)²), as more fully described herein.

When arranging motion vectors associated with the prior decoded blocks of the current video frame, the decoder management component 306 can arrange the prior decoded blocks of the current video frame that are adjacent to the current block, based at least in part on the spatial distance of the respective prior decoded blocks in relation to the current block. With regard to a motion vector associated with a prior decoded block in the current video frame, the spatial distance can be the effective distance, since the temporal distance can be equal to 0, and thus the product of temporal distance and motion-vector magnitude also can be equal to 0.

When arranging the prior decoded blocks of previously decoded video frame(s), the decoder management component 306 can arrange the prior decoded blocks, based at least in part on respective spatial distances of the respective prior decoded blocks in relation to the current block, the respective temporal distances between the previous video frame(s) associated with a prior decoded blocks and the current video frame, and the respective motion-vector magnitudes of these prior decoded blocks.

Each of the prior decoded blocks of the current and previous video frame(s) can be associated with a motion vector (e.g., prior decoded motion vector). The decoder management component 306 can identify the nearest motion vector (e.g., a nearest non-zero motion vector) and the near motion vector (e.g., a non-zero motion vector that is a second closest motion vector) in relation to the current block based at least in part on the arranged order of motion vectors associated with the prior decoded blocks of the current and previous video frames. In accordance with various other aspects, the decoder management component 306 can evaluate and consider one or more other defined motion vectors (e.g., 3^{rd} nearest, 4^{th} nearest, etc.) in addition to the nearest motion vector and near motion vector.

In some implementations, the decoder management component 306 can determine whether the nearest motion vector or near motion vector can be directly used to decode the current block. For example, the decoder management component 306 can determine whether the nearest motion vector or near motion vector can be directly used to decode the current block based at least in part on whether a particular coding mode (e.g., nearest-motion-vector coding mode or near-motion-vector coding mode) is received in relation to the current block.

In certain other implementations, the decoder management component 306 can determine whether the nearest motion vector or near motion vector can be directly used to decode the current block based at least in part on an analysis of the nearest motion vector and the near motion vector. If the decoder management component 306 determines that at least one of the nearest motion vector or near motion vector can be directly used to decode the current block, the decoder management component 306 can determine whether to use the nearest motion vector or near motion vector, based at least in part on the received coding mode.

If a coding mode is received in relation to the current block, the decoder management component 306 can identify the coding mode associated with the current block. The decoder management component 306 can receive the coding mode (if any) with the encoded video bitstream received from the encoder component. The coding mode can be, for example, the nearest-motion-vector coding mode or the near-motion-vector coding mode. In some implementations, the encoder component 302 and decoder component 304 can employ other coding modes, such as zero-motion-vector coding mode or new-motion-vector coding mode, to facilitate coding of video frames. Based at least in part on which of the nearest-motion-vector coding mode or near-motion-vector coding mode (e.g., if either is received) is associated with the current block, the decoder management component 306 can select the nearest motion vector or the near motion vector from the ordered motion vectors associated with the prior decoded blocks.

The decoder component 304 can reuse the selected prior decoded motion vector associated with the received coding mode to decode the current block. In some implementations, the decoder component 304 can decode the current block using the selected prior decoded motion vector to generate a predictor block. The decoder component 304 also can decode an encoded residue block, which can be associated with (e.g., part of) the current block, to generate a decoded residue block. The decoder component 304 can reconstruct the decoded current block by adding the decoded residue block to the predictor block.

Under certain circumstances, the decoder management component 306 can bypass the analysis and determinations relating to ordering prior decoded blocks (and associated prior decoded motion vectors) and/or identifying a nearest motion vector or near motion vector, in relation to decoding a current block. Those circumstances can include, for example, when the decoder management component 306 does not receive a coding mode in relation to the current block, or when the received coding mode is not a nearest-motion-vector coding mode, a near-motion-vector coding mode or other defined coding mode associated with a motion vector order. In response to such circumstances, the decoder management component 306 can determine that no prior decoded motion vector is to be reused to decode the current block, and the decoder component 304 can decode the current block based at least in part on another motion vector that was used to encode the current block.

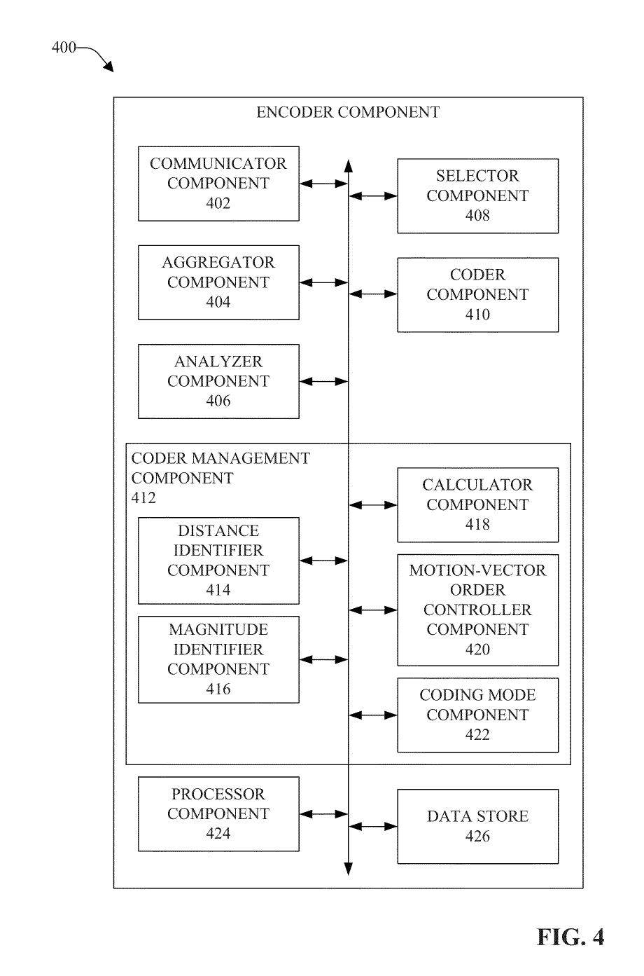

FIG. 4 illustrates a block diagram of an example encoder component 400 in accordance with various aspects and implementations of this disclosure. The encoder component 400 can include a communicator component 402, an aggregator component 404, an analyzer component 406, a selector component 408, and coder component 410.

The communicator component 402 can be used to communicate (e.g., transmit, receive) information between the encoder component 400 and other components (e.g., user interface, media source, media capture device, data store, computer-readable storage media, etc.). The information can include, for example, raw video frames of a video frame sequence, information that can facilitate encoding data associated with raw video frames, information relating to defined encoding criterion or corresponding rules, information relating to encoding parameters, encoding algorithms, etc., that can be used by the encoder component 400 to facilitate enabling the encoder component 400 to encode data. The communicator component 402 also can transmit encoded video frames (e.g., encoded video bitstream) to, for example, a decoder component, user interface, data store, or computer-readable storage media.

The aggregator component 404 can aggregate data received (e.g., obtained) from various entities (e.g., media source, media capture device, processor, data store, coder component, coder management component, user interface, etc.). The aggregator component 404 can correlate respective items of data based at least in part on type of data, source of the data, time or date the data was generated or received, encoding state of the data, a video frame or coding unit to which the data relates, etc., to facilitate analyzing of the data by the analyzer component 406.

The analyzer component 406 can analyze data to facilitate encoding data, ordering of motion vectors used for encoding prior encoded blocks of current and/or previous frames in relation to encoding a current block, identifying nearest and near motion vectors, identifying a coding mode, allocating bits to blocks for encoding of raw video frames, etc. The analyzer component 406 can generate analysis results, based at least in part on the data analysis. For example, in relation to encoding a current block, the analyzer component 406 can analyze desired (e.g., adjacent) prior encoded blocks of a current video frame and one or more previous video frames to facilitate ordering motion vectors used for encoding these prior encoded blocks, in accordance with defined encoding criterion, as more fully described herein. The analyzer component 406 can provide analysis results relating to motion vector ordering to the coder management component 412, and the coder management component 412 can arrange the motion vectors used for encoding the prior encoded blocks in a desired order, in accordance with such analysis results. The analyzer component 406 or an associated component (e.g., coder management component 412) also can identify, e.g., a nearest motion vector and near motion vector, identify whether the nearest motion vector or near motion vector can be used to encode the current block, identify which (if any) of the nearest or near motion vectors to use to encode the current block, etc., based at least in part on the analysis results. The encoder component 400 can use the analysis results to facilitate enabling the coder component 410 to efficiently encode raw video frames of a video frame sequence.

The selector component 408 can select items of data, an applicable encoding-related algorithm (e.g., compression algorithm, ordering algorithm to order motion vectors associated with prior encoded blocks, algorithm relating to identifying or selecting a coding mode, etc.), a block or motion vector, encoding-related parameter values, a coding mode, or other information, to facilitate encoding data, etc. For example, the selector component 408 can select one or more parameters, one or more items of data, etc., relevant to an encoding task (e.g., ordering of motion vectors associated with prior encoded blocks, identifying a nearest motion vector or near motion vector, identifying a coding mode, etc.) being performed by the encoder component 400.

The encoder component 400 also can include a coder component 410 that can encode or compress data associated with a video frame in accordance with a defined encoding or compression algorithm. In some implementations, the coder component 410 can use a specified quantization value that can correspond to the compression level to be used during the encoding of a block (or associated motion vector) of a raw video frame.

The encoder component 400 can include a coder management component 412 that can control encoding of blocks of a raw video frame, as more fully disclosed herein. In some implementations, the coder management component 412 can manage reusing a desired prior encoded motion vector of a desired prior encoded block of a current video frame or previous video frame to efficiently encode a current block, in accordance with defined encoding criterion.

The coder management component 412 can include, for example, a distance identifier component 414, a magnitude identifier component 416, a calculator component 418, a block order controller component 420, and a coding mode component 422. The distance identifier component 414 can identify or calculate an effective distance between one or more desired motion vectors associated with prior encoded blocks in relation to a current block of a current video frame. A desired motion vector associated with a prior encoded block can include prior encoded blocks that are proximate to (e.g., adjacent to) the current block in the current video frame. A prior encoded block also can include a block located in a previous video frame(s) in a position that can correspond to the position of the current block in the current video frame or a position that are adjacent to the current block in the current video frame. The distance identifier component 414 can calculate the effective distance between a motion vector associated with a prior encoded block of a previous video frame in relation to the current block as a function of the magnitude of the motion vector, spatial distance between the prior encoded block (associated with the motion vector) and the current block, and/or temporal distance of that previous video frame in relation to the current video frame, as more fully disclosed herein. The distance identifier component 414 also can calculate the spatial distance between the current block and a prior encoded block of a current video frame that is adjacent to the current block in the current video frame, as more fully disclosed herein. With regard to a prior encoded block of the current video frame, the encoder management component 412 can identify the effective distance for the motion vector associated with that prior encoded block as being equal to the spatial distance between its associated prior encoded block and the current block due at least in part to the temporal distance between that prior encoded block and the current block being equal to 0.

The magnitude identifier component 416 can identify magnitude parameters associated with prior encoded motion vectors of prior encoded blocks, for example, of a previous video frame. The magnitude identifier component 416 can provide magnitude parameters for a prior encoded motion vector of a prior encoded block to the distance identifier component 414 to facilitate identification or calculation of an effective distance between the motion vector associated with the prior encoded block of a previous video frame in relation to a current block of a current video frame.

The calculator component 418 can operate in conjunction with other components (e.g., analyzer component 406, distance identifier component 414, etc.) to perform calculations on data (e.g., data relating to spatial distance, data relating to temporal distance, magnitude values of motion vectors, encoding parameter values, etc.). The calculations can be based at least in part on a mathematical function. For example, the calculator component 418 can calculate an effective distance between a prior encoded block of a previous video frame and a current block in accordance with the mathematical equation: ED=sqrt((MVM1*TD+SD1)²+(MVM2*TD+SD2)²), as more fully disclosed herein. The calculations can also be based at least in part on a probabilistic function.

The motion vector order controller component 420 can compare respective effective distances associated with the motion vectors of desired prior encoded blocks in relation to a current block. The motion vector order controller component 420 can sort, arrange and/or order the motion vectors to order the motion vectors, for example, from closest effective distance to furthest effective distance in relation to the location of the current block.

The coding mode component 422 can identify the prior encoded motion vector (e.g., that is a non-zero motion vector) of the prior encoded block that is closest in effective distance to the current block as a nearest motion vector. The coding mode component 422 also can identify the prior encoded motion vector (e.g., that is a non-zero motion vector) of the prior encoded block that is second closest in effective distance to the current block as a near motion vector. The coding mode component 422 can generate or select a nearest-motion-vector coding mode that can be associated with the nearest motion vector and/or generate or select a near-motion-vector coding mode that can be associated with the near motion vector. If either of the nearest motion vector or the near motion vector is used (e.g., reused) to encode the current block, the encoder component 400 (e.g., using communicator component 402) can transmit the corresponding coding mode in relation to the encoded current block to notify the decoder component regarding which coding mode, and thus which motion vector, to use (e.g., reuse) to decode the encoded current block. As the reused motion vector already has been used in relation to its associated prior encoded block, the encoder component 400 can avoid re-transmitting the corresponding reused motion vector in the encoded video bitstream.

In some implementations, the encoder component 400 also can include a processor component 424 that can operate in conjunction with the other components (e.g., communicator component 402, aggregator component 404, analyzer component 406, etc.) to facilitate performing the various functions of the encoder component 400. The processor component 424 can employ one or more processors, microprocessors, or controllers that can process data to facilitate encoding video content and/or performing other operations associated with the encoder component 400, as more fully disclosed herein. The data may include, for example, information relating to encoding data and/or information relating to other operations of the encoder component 400. The processor component 424 can control data flow between the encoder component 400 and other components (e.g., media source, media capture device, decoder component, data store, computer-readable storage media, etc.) associated with the encoder component 400.

The encoder component 400 also can include a data store 426 that can store data structures (e.g., user data, video content, metadata), instructions, procedures, and/or code structure(s) (e.g., modules, objects, hashes, classes) to facilitate performing or controlling operations associated with the encoder component 400. The data store 426 also can store information (e.g., encoding-related algorithms, coding modes, encoding parameters, encoding criterion, etc.) relating to encoding data, and/or information relating to other operations of the encoder component 400, etc., to facilitate encoding video content, and performing or controlling operations, associated with the encoder component 400. The processor component 424 can be coupled (e.g., through a memory bus) to the data store 426 in order to store and retrieve information desired to operate and/or confer functionality, at least in part, to the components (e.g., communicator component 402, aggregator component 404, analyzer component 406, etc.) of the encoder component 400, and/or substantially any other operational aspects of the encoder component 400.

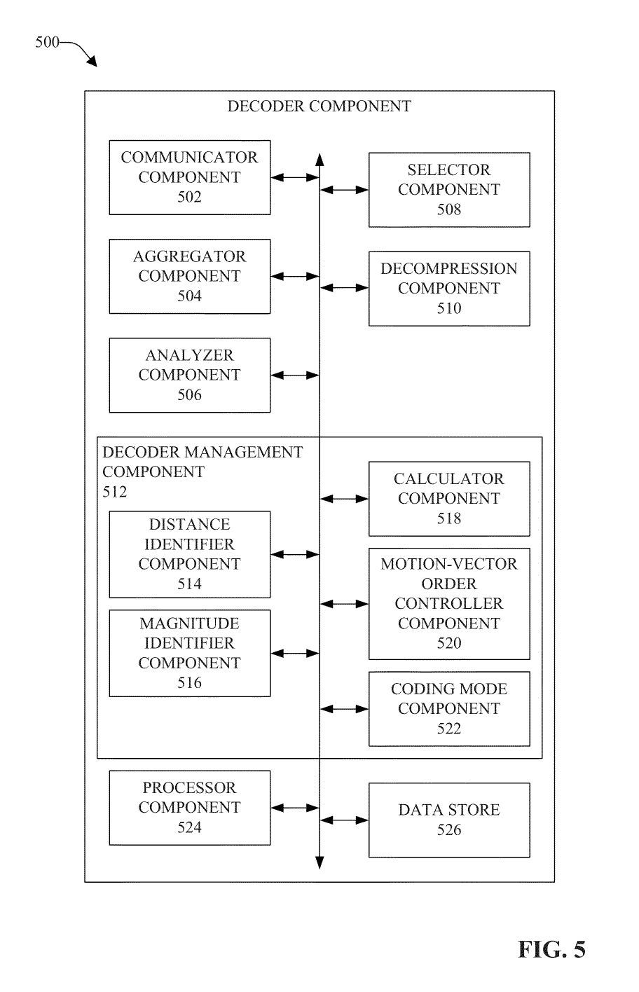

FIG. 5 depicts a block diagram of an example decoder component 500 in accordance with various aspects and implementations of this disclosure. The decoder component 500 can include a communicator component 502, an aggregator component 504, an analyzer component 506, a selector component 508, and a decompression component 510.

The communicator component 502 can communicate (e.g., transmit, receive) information between the decoder component 500 and other components (e.g., encoder component, display component, user interface, media source, data store, computer-readable storage media, etc.). The information can include, for example, received encoded video frames of a video frame sequence, information that can facilitate decoding encoded content, a coding mode associated with an encoded block of a video frame, information relating to defined decoding criterion or corresponding rules, information relating to decoding parameters, decoding algorithms, decoded content presented for display, etc. The decoder component 500 can use the information to facilitate enabling the decoder component 500 to decode encoded content. The communicator component 502 also can transmit decoded video frames (e.g., decoded video bitstream) to, for example, a display component (not shown in FIG. 5).

The aggregator component 504 can aggregate data received (e.g., obtained) from various entities (e.g., processor, data store, encoder component, decoder management component, user interface, etc.). The aggregator component 504 can correlate respective items of data based at least in part on type of data, source of the data, time or date the data was generated or received, encoding state of the data, a video frame to which the data relates, etc., to facilitate analyzing the data.

The analyzer component 506 can analyze data relating to decoding data, ordering of motion vectors associated with prior decoded blocks of current and/or previous video frames in relation to decoding a current block, identifying a nearest motion vector and/or a near motion vector, identifying a coding mode, etc. The analyzer component 506 can generate analysis results, based at least in part on the data analysis. For example, the analyzer component 506 can analyze prior decoded blocks (and associated prior decoded motion vectors) of current and previous video frames to facilitate ordering motion vectors associated with these prior decoded blocks in accordance with defined decoding criterion. The defined decoding criterion can relate to, for example, the spatial distance between a prior decoded block (and associated motion vector) and a current block, the temporal distance between the previous video frame of a prior decoded block and the current video frame, and/or motion-vector magnitude of a prior decoded motion vector associated with a prior decoded block, as more fully described herein. The analyzer component 506 can generate analysis results that can facilitate identifying a nearest motion vector and near motion vector from the prior decoded motion vectors associated with the prior decoded blocks, based at least in part on the motion vector order. Based at least in part on the analysis, the analyzer component 506 also can generate analysis results that can facilitate identifying whether the nearest motion vector or near motion vector can be used to decode the current block and/or identifying which (if any) of the nearest or near motion vectors to use to decode the current block (e.g., based on a received coding mode). The decoder component 500 can use the analysis results to facilitate enabling the decoder component 500 to efficiently decode encoded video frames of a video frame sequence.

The selector component 508 can select items of data, an applicable decoding-related algorithm (e.g., decompression algorithm, prior-decoded-motion-vector ordering algorithm, algorithm relating to identifying a coding mode, etc.), a block (e.g., current block, prior decoded block, etc.) of a video frame, a motion vector, a coding mode, or other information, to facilitate decoding data of an encoded video frame. For example, the selector component 508 can select one or more parameters, one or more items of data, etc., relevant to a decoding task (e.g., ordering of prior decoded motion vectors, identifying a nearest motion vector or near motion vector, identifying a coding mode, etc.) being performed by the decoder component 500.

The decoder component 500 can include a decompression component 510 that can decode or decompress data associated with an encoded video frame in accordance with a defined decoding or decompression algorithm. In some implementations, the decompression component 510 can use a specified quantization value that can correspond to the decompression level to be used during the decoding of an encoded block of a video frame.

The decoder component 500 can include a decoder management component 512 that can efficiently control decoding of encoded blocks of a video frame of an encoded video frame sequence, as more fully disclosed herein. The decoder management component 512 can manage reusing a decoded motion vector of a desired prior decoded block (e.g., adjacent block or a block of a previous video frame that corresponds to an adjacent block) of a current video frame or previous video frame(s) to decode a current block, in accordance with defined decoding criterion.

The decoder management component 512 can include a distance identifier component 514, a magnitude identifier component 516, a calculator component 518, a block order controller component 520, and a coding mode component 522. The distance identifier component 514 can identify or calculate an effective distance between one or more motion vectors associated with desired prior decoded blocks in relation to a current block of a current video frame. A desired prior decoded block can be a prior decoded blocks proximate to (e.g., adjacent to, next to, neighboring, or contiguously surrounding, etc.) the current block in the current video frame. A desired prior decoded block also can be a prior decoded block located in a position in a previous video frame(s) that can correspond to the position of the current block in the current video frame or a position that is proximate to the current block in the current video frame. The distance identifier component 514 can calculate the effective distance between a motion vector associated with a prior decoded block of a previous video frame in relation to the current block as a function of the spatial distance between the prior decoded block and the current block, temporal distance between the previous video frame of the desired prior decoded block and the current video frame, and the magnitude of the motion vector. The distance identifier component 514 also can calculate the effective distance of a motion vector associated with desired (e.g., adjacent) prior decoded block of a current video frame in relation to the current block in the current video frame. The distance identifier component 514 can calculate or measure the spatial distance (e.g., physical distance) of the prior decoded block of the current video frame in relation to the current block in the current video frame. With regard to the prior decoded block of the current video frame, the decoder management component 512 can identify the effective distance for the motion vector associated with that prior decoded block as being equal to the spatial distance between its associated prior decoded block and the current block due at least in part to the temporal distance between that prior decoded block and the current block being equal to 0.

The magnitude identifier component 516 can identify magnitude parameters associated with prior decoded motion vectors of prior decoded blocks, for example, of a previous video frame. The magnitude identifier component 516 can provide magnitude parameters for a prior decoded motion vector of a prior decoded block to the distance identifier component 514 to facilitate identification or calculation of an effective distance between a motion vector associated with a desired prior decoded block of a previous video frame in relation to a current block of a current video frame.

The calculator component 518 can operate in conjunction with other components (e.g., analyzer component 506, distance identifier component 514, etc.) to perform calculations on data (e.g., effective distance values, spatial distance values, temporal distance values, magnitude values of motion vectors, etc.). The calculations can be based at least in part on a mathematical function, e.g., an arithmetic and/or a probabilistic function.

The motion vector order controller component 520 can compare respective distances (e.g., spatial and/or effective distances) between motion vectors associated with desired prior decoded blocks in relation to a current block. The motion vector order controller component 520 can sort, arrange and/or order the motion vectors associated with the desired prior decoded blocks to order the motion vectors from closest effective distance to furthest effective distance in relation to the current block based at least in part on the effective distance comparisons.

The coding mode component 522 can identify a type of coding mode received in relation to a current block of a current video frame. For example, the coding mode component 522 can identify whether the received coding mode is a nearest-motion-vector coding mode that can be associated with the nearest motion vector or a near-motion-vector coding mode that can be associated with the near motion vector, when either of such coding modes is received by the decoder component 500 in relation to a block (e.g., current encoded block). The coding mode component 522 can identify the prior decoded motion vector (e.g., that is a non-zero motion vector) of the prior decoded block that is closest in effective distance to the current block as a nearest motion vector, based at least in part on the motion vector order. The coding mode component 522 also can identify the prior decoded motion vector (e.g., that is a non-zero motion vector) of the prior decoded block that is second closest in distance to the current block as a near motion vector, based at least in part on the motion vector order. The coding mode component 522 (in conjunction with the selector component 508) can select a desired prior decoded motion vector based at least in part on the received coding mode (e.g., nearest-motion-vector coding mode, near-motion-vector coding mode) and the motion vector order. The decompression component 510 can decode the current encoded block based at least in part on the selected prior decoded motion vector.

In some implementations, the decoder component 500 also can include a processor component 524 that can operate in conjunction with the other components (e.g., communicator component 502, aggregator component 504, analyzer component 506, etc.) to facilitate performing the various functions of the decoder component 500, as more fully disclosed herein. The processor component 524 can employ one or more processors, microprocessors, or controllers that can process data, such as information relating to decoding data, information relating to other operations of the decoder component 500, and/or other information, etc., to facilitate decoding encoded video content and/or performing other operations associated with the decoder component 500, as more fully disclosed herein. The processor component 524 also can control data flow between the decoder component 500 and other components (e.g., encoder component, data store, computer-readable storage media, display component, etc.) associated with the decoder component 500.

The decoder component 500 also can include a data store 526 that can store data structures (e.g., user data, metadata), instructions, procedures, and/or code structure(s) (e.g., modules, objects, hashes, classes) to facilitate performing or controlling operations associated with the decoder component 500. The data store 526 also can store information (e.g., decoding-related algorithms, coding modes, decoding parameters, decoding criterion, etc.) relating to decoding data and other information relating to other operations of the decoder component 500, to facilitate decoding video content, and performing or controlling operations, associated with the decoder component 500. The processor component 524 can be coupled (e.g., through a memory bus) to the data store 526 in order to store and retrieve information desired to operate and/or confer functionality, at least in part, to the components (e.g., communicator component 502, aggregator component 504, analyzer component 506, etc.) of the decoder component 500, and/or substantially any other operational aspects of the decoder component 500.

While implementations and aspects of this disclosure are described herein with regard to blocks, this disclosure is not so limited. For example, the implementations and aspects disclosed herein in relation to blocks can be used (e.g., applied) in relation to various types of units or regions of a video frame, such as, for example, macroblocks, sub-macroblocks, coding units, motion granularity units, partitions, and/or other types of image compression units, and these various types of image compression units are within the scope of this disclosure.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

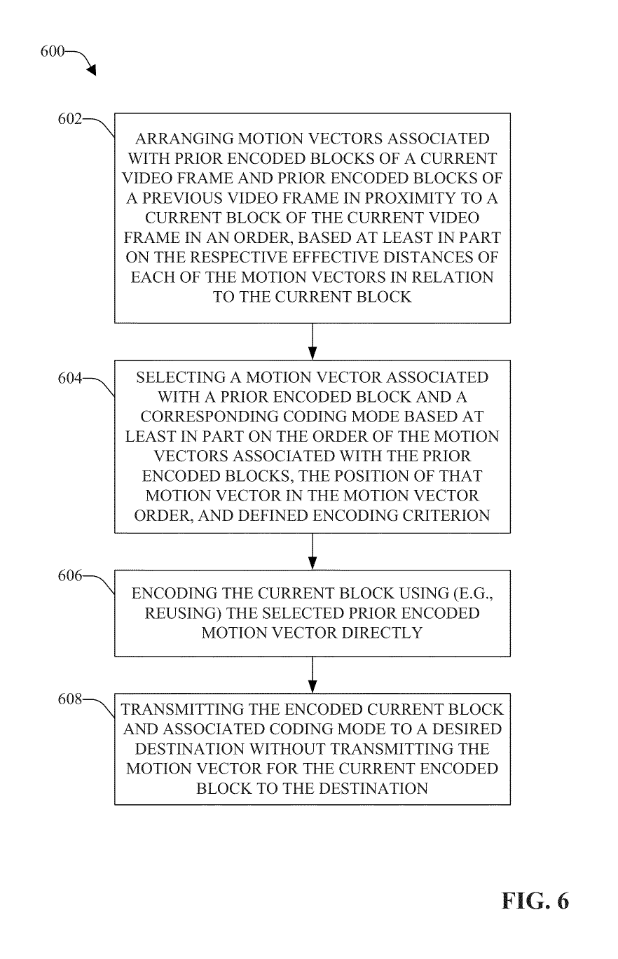

In view of the example systems, components, and devices described above, example methods that can be implemented in accordance with this disclosure can be further appreciated with reference to flowcharts in FIGS. 6-8. For purposes of simplicity of explanation, various methods disclosed herein are presented and described as a series of acts; however, it is to be understood and appreciated that this disclosure is not limited by the order of acts, as some acts may occur in different order and/or concurrently with other acts from that shown and described herein. It is noted that not all illustrated acts may be required to implement a described method in accordance with this disclosure. In addition, for example, one or more methods disclosed herein could alternatively be represented as a series of interrelated states or events, such as in a state diagram. Moreover, interaction diagram(s) or call flow(s) represent several of the example methods disclosed herein in accordance with the described subject matter; particularly in instances when disparate entities, or functional elements, enact disparate portions of one or more of the several methods. Furthermore, two or more of the disclosed example methods can be implemented in combination, to accomplish one or more features or advantages described in this disclosure.

With reference first to FIG. 6, illustrated is a flow chart of an example method 600 for encoding a current block of a raw video frame of a video frame sequence, in accordance with various aspects and implementations. The method 600 can be used, for example, by an encoder component, which can include a coder component and coder management component.

At 602, motion vectors associated with prior encoded blocks of a current video frame and prior encoded blocks of a previous video frame in proximity to a current block of the current video frame can be arranged in an order, based at least in part on the respective effective distances of each of the motion vectors in relation to the current block. The coder management component can identify an effective distance of a motion vector associated with a prior encoded block as a function of spatial distance between the prior encoded block and the current block, temporal distance between the video frame of a prior encoded block and the current video frame, and the motion-vector magnitude of the motion vector. The coder management component can identify respective spatial distances of prior encoded blocks (associated with prior encoded motion vectors) of the current video frame that are adjacent to (e.g., next to, proximate to, neighboring, surrounding, or contiguously surrounding, etc.) the current block in the current video frame. The coder management component also can identify respective spatial distances of prior encoded blocks (associated with prior encoded motion vectors) of the previous video frame that are located in positions that correspond to locations in the current video frame that are adjacent to the location, or are at the location, of the current block in the current video frame. The code management component also can determine or identify the temporal distance between, for example, a previous video frame(s) (associated with a motion vector under consideration) and the current video frame. The coder management component can determine or identify the respective magnitudes of the motion vectors (e.g., prior encoded motion vectors) associated with these prior encoded blocks of the previous video frame.

The coder management component can determine or identify a desired motion vector ordering of these motion vectors associated with prior encoded blocks of the current and previous video frames based at least in part on the respective effective distances of the motion vectors of the prior encoded blocks in relation to the current block. For instance, the coder management component can arrange motion vectors associated with these prior encoded blocks in order from closest to furthest in effective distance in relation to the current block.

At 604, a motion vector associated with a prior encoded block and a corresponding coding mode can be selected based at least in part on the order of the motion vectors associated with the prior encoded blocks, the position (e.g., rank) of that motion vector in the motion vector order, and defined encoding criterion. The coder management component can identify the motion vector that is first in the motion vector order as the nearest motion vector. The coder management component also can identify the motion vector that is second in the motion vector order as the near (e.g., second nearest or second closest) motion vector.

The coder management component can determine whether either of the nearest motion vector or the near motion vector can be used directly to encode the current block. If the coder management component determines that at least one of the nearest motion vector or near motion vector can be used directly to encode the current block, the coder management component can identify or determine whether the current block will be encoded most efficiently using the nearest motion vector or the near motion vector. The coder management component can select either the nearest motion vector or the near motion vector for use in encoding the current block based at least in part on which prior encoded motion vector is determined to be most efficient for encoding the current block. If the coder management component determines the current block will be encoded most efficiently using the nearest motion vector, the coder management component can select the nearest motion vector for encoding the current block, and can select the associated nearest-motion-vector coding mode. If the coder management component determines the current block will be encoded most efficiently using the near motion vector, the coder management component can select the near motion vector for encoding the current block, and can select the associated near-motion-vector coding mode.

At 606, the selected prior encoded motion vector can be used (e.g., reused) directly to encode the current block to generate an encoded current block. The selected prior encoded motion vector can be one of the nearest motion vector or the near motion vector. The coder component can use the selected prior encoded motion vector directly to encode the current block, as more fully disclosed herein.

At 608, the encoded current block and associated coding mode can be transmitted to a desired destination (e.g., decoder component, data store, computer-readable storage media, etc.) without transmitting the motion vector for the current encoded block to the destination. The encoder component can transmit the encoded current block, which can include or be associated with an encoded residue block, and associated coding mode to the desired destination. The motion vector used to encode the current block is a prior encoded motion vector that is being reused to encode the current block. The coder management component already has transmitted, or already was going to transmit, the prior encoded motion vector to the destination in relation to the prior encoded block associated with the prior encoded motion vector. The destination (e.g., decoder component associated with the destination) will be able to identify the prior encoded motion vector (associated with a prior decoded block) used to encode the current block using the coding mode associated with the encoded current block. As a result, the encoder component can avoid re-transmitting the prior encoded motion vector to the destination in relation to the current encoded block. This can reduce the number of bits used to encode the current block, and thus, can reduce the number of bits used to transmit or store the encoded current block, as compared to conventional encoding methods and systems.

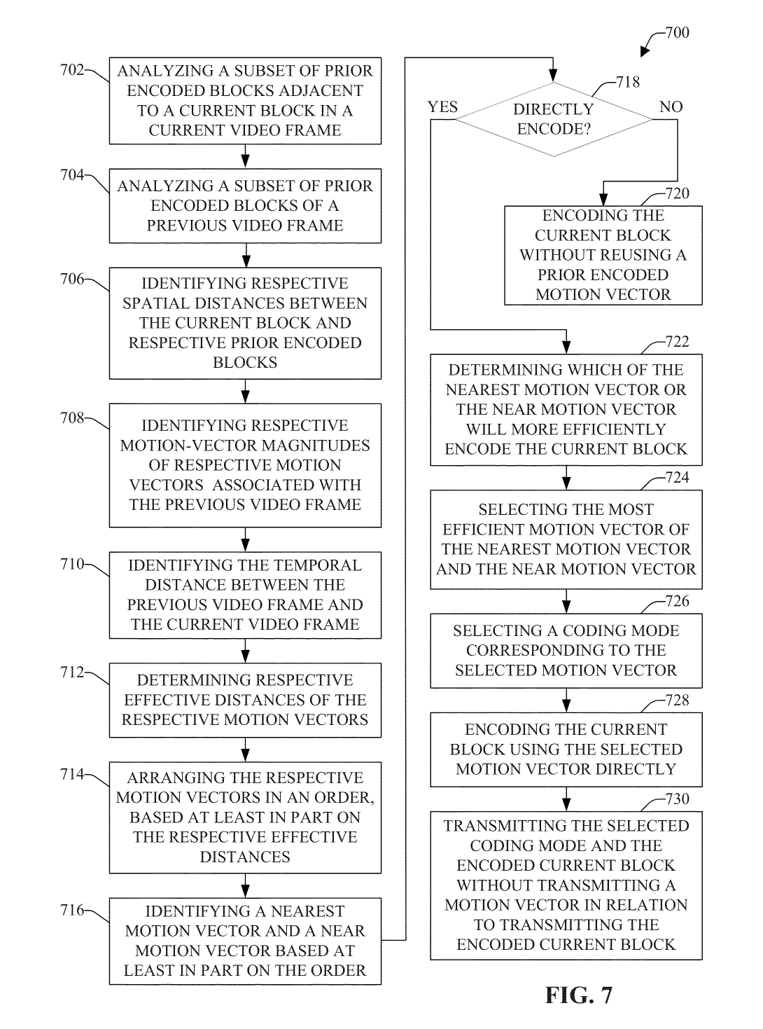

Referring next to FIG. 7, depicted is a flow chart of another example method 700 for encoding a current block of a raw video frame of a video frame sequence, in accordance with various aspects and implementations. The method 700 can be used, for example, by an encoder component, to efficiently encode blocks of a video frame sequence (e.g., to generate an encoded video bitstream).

At 702, a subset of prior encoded blocks that are adjacent to a current block in a current video frame can be analyzed (e.g., by an analyzer component). The current video frame can be part of a video frame sequence that includes video content being encoded by an encoder component. The encoder component can be preparing to encode the current block. The analyzer component (or coder management component operating in conjunction with the analyzer component) can analyze the subset of prior encoded blocks to facilitate determining whether to reuse a prior encoded motion vector of a prior encoded block to encode the current block.

At 704, a subset of prior encoded blocks of a previous video frame can be analyzed (e.g., by the analyzer component). The respective prior encoded blocks in the subset of prior encoded blocks of the previous video frame can be respectively located in the previous video frame to correspond to locations in the current video frame that are at the location of the current block or adjacent to the current block in the current video frame. The analyzer component (or coder management component operating in conjunction with the analyzer component) also can analyze this subset of prior encoded blocks of the previous video frame to facilitate determining whether to reuse a motion vector of a prior encoded block (e.g., of the current or previous video frames) to encode the current block.

At 706, respective spatial distances between the current block and respective prior encoded blocks of the subset of prior encoded blocks of the current video frame and the subset of prior encoded blocks of the previous video frame can be identified. The coder management component can identify, measure, or calculate the respective spatial distances of respective prior encoded blocks associated with respective motion vectors in relation to the current block.

At 708, respective motion-vector magnitudes of the respective motion vectors (e.g., prior encoded motion vectors) associated with the respective prior encoded blocks of the subset of prior encoded blocks of the previous video frame can be identified. The coder management component can identify, measure, or determine the respective motion-vector magnitudes of these motion vectors. At 710, the temporal distance between the previous video frame and the current video frame can be identified. The coder management component can identify, measure, or determine the temporal distance between the previous video frame associated with these motion vectors and the current video frame.

At 712, respective effective distances between respective motion vectors associated with the prior encoded blocks in relation to the current block can be determined. The respective effective distances of respective motion vectors of prior encoded blocks of the subset of prior encoded blocks of the current video frame can be equal to the respective spatial distances between the prior encoded blocks in relation to the current block, since the temporal distance associated with these motion vectors is 0. The coder management component can identify or determine the respective effective distances of motion vectors of the prior encoded blocks of the previous video frame as a function of the respective spatial distances between these respective prior encoded blocks in relation to the current block, the temporal distance between the previous video frame and current video frame, and the respective motion-vector magnitudes of these motion vectors. The coder management component can use a desired mathematical function, as more fully disclosed herein, to calculate the respective effective distances between the current block and respective motion vectors associated with prior encoded blocks of the previous video frame.

At 714, the respective motion vectors associated with prior encoded blocks of the current and previous video frames can be arranged in an order, based at least in part on the respective effective distances associated with these respective motion vectors. In some implementations, the coder management component can identify a motion vector order and/or can arrange the motion vectors (and associated prior encoded blocks) in order from closest to furthest in effective distance in relation to the current block, in accordance with the respective distances associated with these respective motion vectors.

At 716, a nearest motion vector and a near motion vector can be identified, based at least in part on the order of the respective motion vectors. The coder management component can identify the closest non-zero prior-encoded motion vector as the nearest motion vector (e.g., first motion vector in the order). For example, the coder management component can identify the motion vector that is closest in effective distance to the current block from the motion vector order. If that motion vector is a non-zero motion vector, the coder management component can identify that motion vector as the nearest motion vector. A near motion vector can also be identified. The coder management component can identify the second closest non-zero prior-encoded motion vector as the near motion vector (e.g., second motion vector in the order), in accordance with the order of the respective motion vectors.

At 718, a determination can be made regarding whether the nearest motion vector or the near motion vector can be used directly for encoding the current block. The coder management component can analyze information relating to the nearest and near motion vectors, and the current block, to determine whether either of the nearest motion vector or the near motion vector can be used directly for encoding the current block, in accordance with defined encoding criterion. If it is determined that neither of the nearest motion vector or the near motion vector is to be be used for encoding the current block, at 720, the current block can be encoded without reusing any of the prior encoded motion vectors associated with the prior encoded blocks of the current and previous video frames.

Referring again to reference numeral 718, if, at 718, it is determined that at least one of the nearest motion vector or the near motion vector can be used for encoding the current block, at 722, a determination can be made regarding which of the nearest motion vector or the near motion vector will more efficiently encode the current block. The coder management component can evaluate information relating to the current block, the nearest motion vector and the near motion vector to determine which of the nearest motion vector or the near motion vector will more efficiently encode the current block, in accordance with defined encoding criterion.

At 724, the most efficient motion vector (e.g., prior encoded motion vector) of the nearest motion vector and the near motion vector can be selected (e.g., by the coder management component (e.g., using a selector component)). At 726, a coding mode corresponding to the selected motion vector can be selected (e.g., by the coder management component). The selected coding mode can be, for example, a nearest-motion-vector coding mode when the nearest motion vector is selected, or a near-motion-vector coding mode when the near motion vector is selected.

At 728, the current block can be encoded using the selected motion vector to generate an encoded current block. The coder component can use the selected prior encoded motion vector to encode the current block. At 730, the selected coding mode and the encoded current block can be transmitted without transmitting (e.g., re-transmitting) the motion vector in relation to transmitting the encoded current block. The encoder component (e.g., using its communicator component) can transmit the selected coding mode and an encoded residue block of the encoded current block to a desired destination, such as, for example, a decoder component, a data store, or computer-readable storage media, without transmitting the motion vector for the current block to the destination. Transmitting the motion vector in relation to transmitting the current block can be avoided, because, during decoding of the encoded current block, a decoder component associated with the destination can use the selected coding mode to identify a prior decoded motion vector of a prior decoded block to reuse when decoding the encoded current block, as more fully disclosed herein.

In some implementations, as desired, the method 700 can be extended to evaluate other ordered motion vectors (e.g., 3^{rd} motion vector in the order, 4^{th} motion vector in the order, etc.) in addition to the nearest motion vector (e.g., 1^{st} motion vector in the order) and near motion vector (e.g., 2^{nd} motion vector in the order), in accordance with applicable defined encoding criterion. For example, in some instances, the coder management component can evaluate the first four motion vectors in the motion vector order to determine which of the first four motion vectors in the order is suitable and/or most efficient for reuse in encoding a current block. Based at least in part on analysis results, the coder management component can select the motion vector (and can select the corresponding coding mode) of the first four motion vectors in the order that is most efficient as compared to the other three motion vectors.

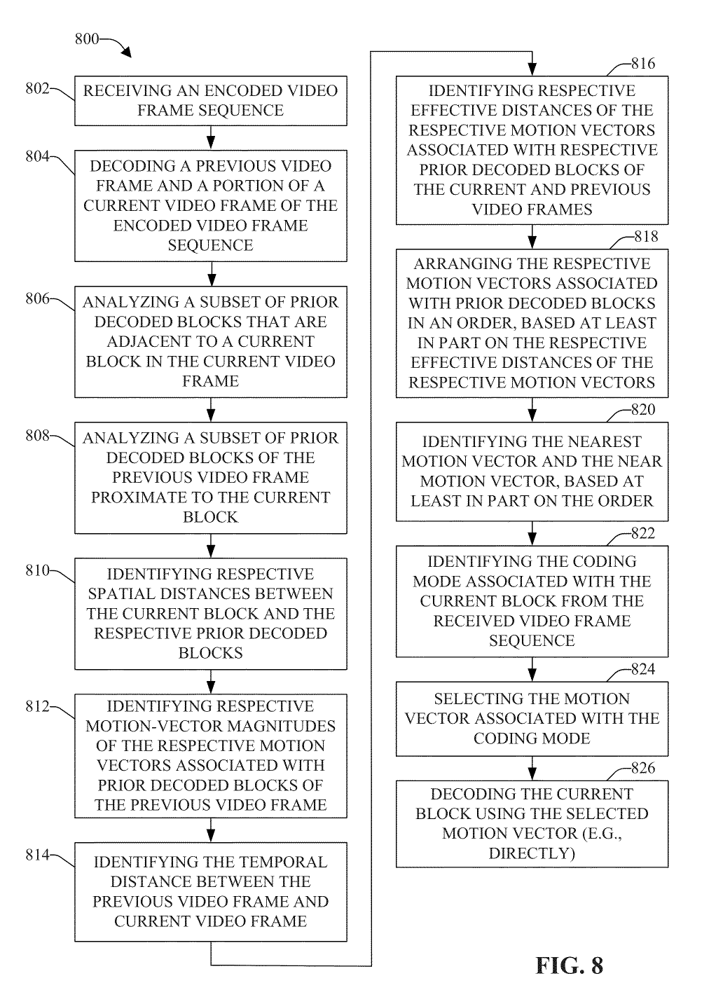

FIG. 8 illustrates a flow chart of an example method 800 for efficiently decoding a current encoded block of a video frame of a video frame sequence, in accordance with various aspects and implementations. The method 800 can be used, for example, by a decoder component, to decode encoded blocks of an encoded video frame sequence (e.g., encoded video bitstream).

At 802, an encoded video frame sequence can be received (e.g., by a decoder component). The decoder component can receive the encoded video frame sequence from, for example, an encoder component, a data store, or computer-readable storage media. The encoded video frame sequence can include encoded video frames and other associated information, such as a coding mode(s) for use in decoding encoded blocks of video frames, metadata, parameter values, etc.

At 804, a previous video frame and a portion of a current video frame of the encoded video frame sequence can be decoded. The decoder component can begin to decode encoded video frames of the encoded video frame sequence. For instance, the decoder component can decode at least a portion (e.g., a subset of blocks and associated motion vectors) of the current video frame up to the point of a current block to be decoded in for the current video frame. The decoder component also can have previously decoded the blocks (and associated motion vectors) of the previous video frame.

At 806, a subset of prior decoded blocks that are adjacent to (e.g., next to, surrounding, or contiguously surrounding, etc.) a current block in the current video frame can be analyzed (e.g., by an analyzer component associated with the decoder component) in relation to decoding the current block. At 808, a subset of prior decoded blocks of the previous video frame proximate to the current block can be analyzed (e.g., by the analyzer component). The subset of prior decoded blocks of the previous video frame can include prior decoded blocks that are proximate to (e.g., “adjacent” to) the current block. For instance, the respective prior decoded blocks in the subset of prior decoded blocks of the previous video frame can be respectively located in the previous video frame to correspond to locations in the current video frame that are at the location of the current block or adjacent to the current block in the current video frame.

The decoder management component (e.g., operating in conjunction with the analyzer component) can analyze these prior decoded blocks of the current and previous video frames to facilitate ordering motion vectors associated with the prior decoded blocks, in accordance with respective effective distances of the respective motion vectors in relation to the current block. The decoder management component can identify the desired motion vector to reuse based at least in part on the received coding mode and the ordering of the motion vectors. The desired motion vector and its place in the motion vector order can be associated with the coding mode.

At 810, respective spatial distances between the current block and respective prior decoded blocks of the subset of prior decoded blocks of the current video frame and the subset of prior decoded blocks of the previous video frame can be identified. The decoder management component can identify, measure, or calculate the respective spatial distances between respective prior decoded blocks associated with the respective motion vectors (e.g., prior decoded motion vectors) in relation to the current block.

At 812, the respective motion-vector magnitudes of the respective motion vectors associated with the respective prior decoded blocks of the subset of prior decoded blocks of the previous video frame can be identified. The decoder management component can identify, measure, or determine the respective motion-vector magnitudes of these motion vectors. At 814, the temporal distance between the previous video frame and current video frame can be identified. The decoder management component can identify, measure, or determine the temporal distance from the previous video frame to the current video frame.

At 816, respective effective distances of the respective motion vectors associated with respective prior decoded blocks of the current and previous video frames can be identified. The decoder management component can identify respective effective distances of the motion vectors associated with respective prior decoded blocks of the current and previous video frames as a function of spatial proximity of the prior decoded blocks associated with the motion vectors in relation to the current block, the identified motion-vector magnitudes of the motion vectors, and the identified temporal distance.

At 818, the respective motion vectors associated with prior decoded blocks can be arranged in an order, based at least in part on the respective effective distances of the respective motion vectors associated with the respective prior decoded blocks. The decoder management component can identify a motion vector order and/or can arrange the motion vectors associated with prior decoded blocks in order, for example, from closest to furthest in effective distance in relation to the current block, in accordance with the respective effective distances associated with the respective motion vectors associated with the prior decoded blocks.

At 820, the nearest motion vector and the near motion vector of the respective motion vectors associated with the motion vector order can be identified, based at least in part on the order of the respective motion vectors in the motion vector order. The decoder management component can identify the non-zero motion vector closest in effective distance to the current block as the nearest motion vector, and can identify the non-zero motion vector that is second closest in effective distance to the current block as the near motion vector, in accordance with the order of the respective prior decoded blocks. For example, the decoder management component can identify the motion vector associated with the prior decoded block that is closest in effective distance to the current block from the motion vector order. If the prior decoded motion vector of that closest prior decoded block is a non-zero motion vector, the decoder management component can identify that prior decoded motion vector as the nearest motion vector (e.g., motion vector that is 1^{st} in the motion vector order).

At 822, the coding mode associated with the current block can be identified from the received video frame sequence (e.g., by the decoder management component). The coding mode can be, for example, a nearest-motion-vector coding mode when the nearest motion vector was selected for use in encoding the current block, or a near-motion-vector coding mode when the near motion vector was selected for encoding the current block.

At 824, the motion vector (e.g., prior decoded motion vector) associated with the coding mode can be selected. The decoder management component can select the motion vector based at least in part on the position of the motion vector (and associated prior decoded block) in the motion vector order and the coding mode. At 826, the current block can be decoded using the selected motion vector (e.g., directly) to generate a decoded current block. The decoder component can use the selected motion vector to decode the current block.

In some implementations, as desired, the method 800 can be extended to evaluate other ordered motion vectors (e.g., 3^{rd} motion vector in the order, 4^{th} motion vector in the order, etc.) in addition to the nearest motion vector (e.g., 1^{st} motion vector in the order) and near motion vector (e.g., 2^{nd} motion vector in the order), in accordance with applicable defined decoding criterion. For example, in some implementations, the decoder management component can order the motion vectors associated with desired prior decoded blocks of the current and previous video frames, and can identify the first four motion vectors in the motion vector order. Based at least in part on analysis results, the decoder management component can select the motion vector (e.g., motion vector that is 3^{rd} in the order) associated with the corresponding coding mode (e.g., 3^{rd}-nearest-motion-vector coding mode) received by the decoder management component with the coded video bitstream.

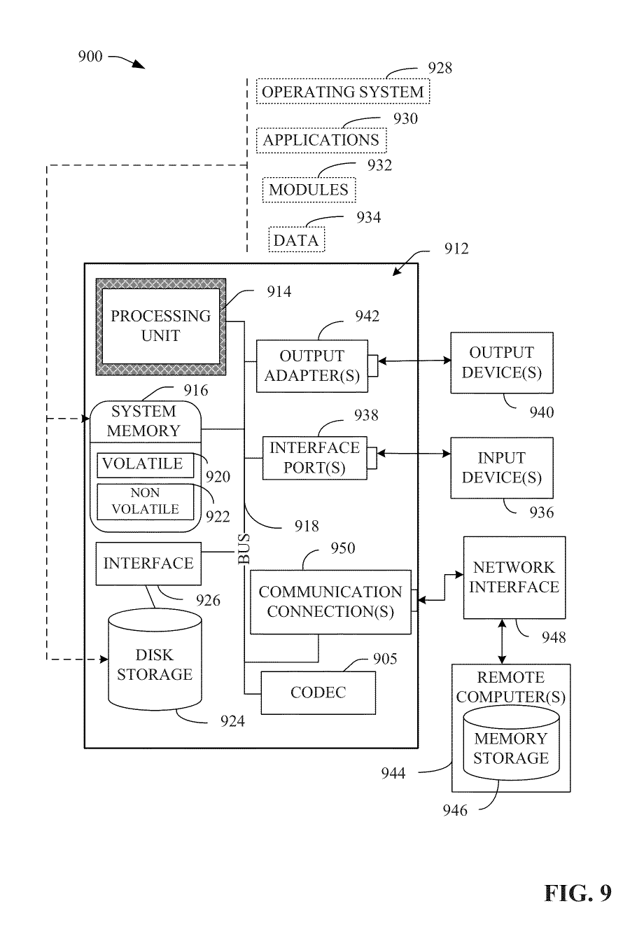

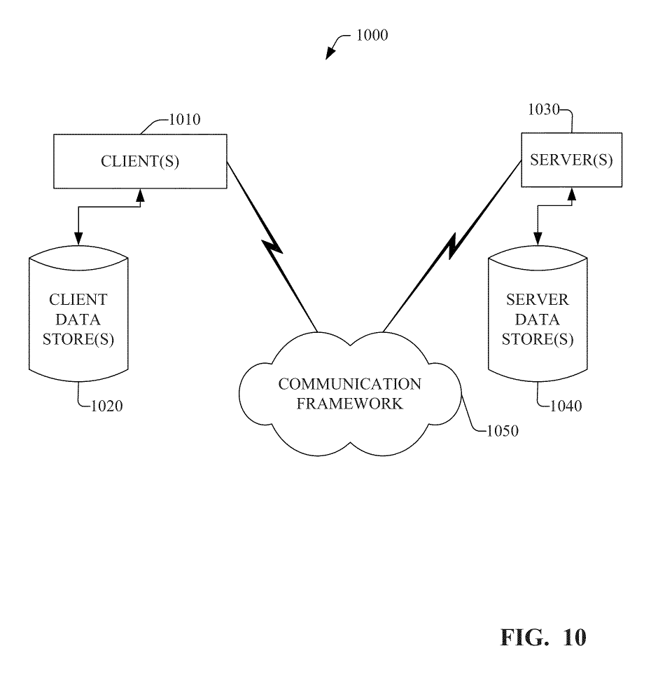

In order to provide a context for the various aspects of the disclosed subject matter, FIGS. 9 and 10 as well as the following discussion are intended to provide a brief, general description of a suitable environment in which the various aspects of the disclosed subject matter may be implemented.

With reference to FIG. 9, a suitable environment 900 for implementing various aspects of this disclosure includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 912 also includes removable/non-removable, volatile/non-volatile computer storage media. FIG. 9 illustrates, for example, a disk storage 924. Disk storage 924 includes, but is not limited to, devices like a magnetic disk drive, floppy disk drive, tape drive, Jaz drive, Zip drive, LS-100 drive, flash memory card, or memory stick. The disk storage 924 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used, such as interface 926.

FIG. 9 also depicts software that acts as an intermediary between users and the basic computer resources described in the suitable operating environment 900. Such software includes, for example, an operating system 928. Operating system 928, which can be stored on disk storage 924, acts to control and allocate resources of the computer system 912. System applications 930 take advantage of the management of resources by operating system 928 through program modules 932 and program data 934, e.g., stored either in system memory 916 or on disk storage 924. It is to be appreciated that this disclosure can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

In accordance with various aspects and implementations, the computer 912 can be used to encode data, such as digital media data, which can be in the form of a sequence of video frames (e.g., raw video frames). As more fully disclosed herein, in some implementations, the computer 912 can include a plurality of processors that can be used to process data and perform computing tasks (e.g., encoding-related tasks and/or decoding-related tasks, etc.). In certain exemplary embodiments, the computer 912 includes a codec 905 that can contain, for example, an encoder component and/or decoder component, each of which can respectively function as more fully disclosed herein. The codec 905 can perform various encoding tasks (e.g., generating motion estimations and motion vectors, encoding blocks and associated motion vectors, determining whether to reuse a prior encoded motion vector to encode a current block, identifying a coding mode associated with a current block, allocating bits for encoding of a current block, etc.) on data (e.g., sequentially or in parallel). The codec 905 can perform various decoding tasks (e.g., decoding blocks and associated motion vectors, determining whether to reuse a prior decoded motion vector to decode a current block, identifying a coding mode associated with a current block, etc.) on data (e.g., sequentially or in parallel).

FIG. 10 is a schematic block diagram of a sample-computing environment 1000 with which the subject matter of this disclosure can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing this disclosure, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. The client(s) 1010 are operatively connected to one or more client data store(s) 1020 that can be employed to store information local to the client(s) 1010. Similarly, the server(s) 1030 are operatively connected to one or more server data store(s) 1040 that can be employed to store information local to the servers 1030.

It is to be appreciated and understood that components (e.g., encoder component, codec, coder component, coder management component, decoder component, decoder management component, etc.), as described with regard to a particular system or method, can include the same or similar functionality as respective components (e.g., respectively named components or similarly named components) as described with regard to other systems or methods disclosed herein.

It is to be noted that aspects or features of this disclosure can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Various aspects or features described herein can be implemented as a method, apparatus, system, or article of manufacture using standard programming or engineering techniques. In addition, various aspects or features disclosed in this disclosure can be realized through program modules that implement at least one or more of the methods disclosed herein, the program modules being stored in a memory and executed by at least a processor. Other combinations of hardware and software or hardware and firmware can enable or implement aspects described herein, including a disclosed method(s). The term “article of manufacture” as used herein can encompass a computer program accessible from any computer-readable device, carrier, or storage media. For example, computer readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or methods herein are intended to include, without being limited to including, these and any other suitable types of memory.

What has been described above includes examples of systems and methods that provide advantages of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system that encodes video frames, comprising:
at least one memory that stores computer executable components; and
at least one processor that executes the following computer executable components stored in the at least one memory:
a coder management component configured to arrange a subset of prior encoded motion vectors associated with prior encoded blocks of a first subset of prior encoded blocks of a current video frame and a second subset of prior encoded blocks of a previous video frame in a motion vector order, based at least in part on respective effective distances of the respective motion vectors of the subset of motion vectors in relation to a current block of the current video frame,
wherein the coder management component is further configured to select a coding mode and a prior encoded motion vector of the subset of prior encoded motion vectors included in the motion vector order, based at least in part on the motion vector order, and
wherein the current video frame and the previous video frame are part of a sequence of video frames; and
a coder component configured to encode the current block using the prior encoded motion vector directly to generate an encoded current block.

2. The system of claim 1, wherein the coder management component is further configured to determine an effective distance for a specified motion vector associated with a specified prior encoded block of the second subset as a function of spatial distance of the specified prior encoded block in relation to the current block, temporal distance between the previous video frame and the current video frame, and a motion-vector magnitude of the specified motion vector.

3. The system of claim 1, wherein the coder management component is further configured to determine an effective distance for a particular motion vector associated with a particular prior encoded block of the first subset as a function of spatial distance of the particular prior encoded block in relation to the current block.

4. The system of claim 1, wherein the first subset of prior encoded blocks comprises prior encoded blocks that are adjacent to the current block in the current video frame, and the second subset of prior encoded blocks comprises prior encoded blocks that are located in positions within the previous video frame that correspond to a location of the current block or locations in the current video frame that are adjacent to the current block.

5. The system of claim 1, further comprising:
an analyzer component configured to analyze prior encoded blocks of the first subset of prior encoded blocks to identify respective effective distances of motion vectors respectively associated with prior encoded blocks of the first subset of prior encoded blocks in relation to the current block, wherein the respective effective distances of motion vectors respectively associated with prior encoded blocks of the first subset of prior encoded blocks are determined as a function of respective spatial distances of the prior encoded blocks of the first subset of prior encoded blocks in relation to the current block.

6. The system of claim 5, wherein the analyzer component is further configured to analyze prior encoded blocks of the second subset of prior encoded blocks to identify respective spatial distances of the prior encoded blocks of the second subset of prior encoded blocks in relation to the current block.

7. The system of claim 6, wherein the analyzer component is further configured to determine respective effective distances of the motion vectors respectively associated with the prior encoded blocks of the second subset of prior encoded blocks as a function of the respective spatial distances of the prior encoded blocks of the second subset of prior encoded blocks, temporal distance between the previous video frame and the current video frame, and respective motion-vector magnitudes of the motion vectors respectively associated with the prior encoded blocks of the second subset of prior encoded blocks.

8. The system of claim 6, wherein the coder management component is further configured to generate the motion vector order based at least in part on the respective effective distances of the motion vectors respectively associated with the prior encoded blocks of the first subset of prior encoded blocks and the respective effective distances of the motion vectors respectively associated with the prior encoded blocks of the second subset of prior encoded blocks.

9. The system of claim 8, wherein the coder management component is further configured to adjust order of respective motion vectors of the subset of motion vectors contained in the motion vector order in response to determining that a same motion vector appears in the motion vector order more than one time.

10. The system of claim 1, wherein the coder management component is further configured to identify a nearest motion vector and a near motion vector from the subset of motion vectors, based at least in part on the motion vector order, and select one of the nearest motion vector or the near motion vector to be the prior encoded motion vector.

11. The system of claim 10, wherein the nearest motion vector is associated with a first motion vector of the subset of motion vectors that is in first position in the motion vector order, and the near motion vector is associated with a second motion vector of the subset of motion vectors that is in second position in the motion vector order.

12. The system of claim 11, wherein the first motion vector is closest in effective distance in relation to the current block, and the second motion vector is second closest in effective distance in relation to the current block.

13. The system of claim 10, wherein selecting one of the nearest motion vector or the near motion vector to be the prior encoded motion vector is based on a defined encoding criterion, wherein the defined encoding criterion relates to at least one of respective number of bits to be used to encode the current block using the nearest motion vector or the near motion vector, respective encoding error of the current block using the nearest motion vector or the near motion vector, or respective amounts of time to be used to encode the current block using the nearest motion vector or the near motion vector.

14. The system of claim 1, further comprising a communicator component configured to transmit the encoded current block and the coding mode without transmission of a motion vector associated with the current block in relation to transmission of the encoded current block.

15. The system of claim 14, wherein the communicator component is further configured to transmit the encoded current block and the coding mode to a destination, wherein the coding mode indicates the motion vector that was re-used to encode the current block to generate the encoded current block.

16. A method for encoding video frames, comprising:
employing at least one processor to facilitate execution of code instructions retained in at least one memory device, the at least one processor, in response to execution of the code instructions, performs acts comprising:
arranging respective prior encoded motion vectors associated with prior encoded blocks of a first subset of prior encoded blocks of a current video frame and a second subset of prior encoded blocks of a previous video frame in a specified order, based at least in part on respective effective distances of the respective prior encoded motion vectors in relation to a current block in the current video frame, wherein the current video frame and the previous video frame are part of a sequence of video frames;
selecting a prior encoded motion vector from a subset of the respective prior encoded motion vectors, based at least in part on the specified order; and
selecting a coding mode based at least in part on position of the prior encoded motion vector in the specified order.

17. The method of claim 16, further comprising:
arranging the respective prior encoded motion vectors in the specified order, based at least in part on respective spatial distances of the respective prior encoded blocks in relation to the current block, temporal distance between the previous video frame and the current video frame, and respective motion-vector magnitudes of the respective prior encoded motion vectors.

18. The method of claim 16, wherein the first subset of prior encoded blocks comprises prior encoded blocks that are adjacent to the current block in the current video frame, and the second subset of prior encoded blocks comprises prior encoded blocks that are located in positions within the previous video frame that correspond to a location of the current block or locations in the current video frame that are adjacent to the current block.

19. The method of claim 16, further comprising:
analyzing prior encoded blocks of the first subset of prior encoded blocks associated with the current video frame to identify respective spatial distances of the prior encoded blocks of the first subset of prior encoded blocks in relation to the current block; and
determining respective effective distances of the respective prior encoded motion vectors associated with the prior encoded blocks of the first subset of prior encoded blocks as a function of the respective spatial distances of the prior encoded blocks of the first subset of prior encoded blocks.

20. The method of claim 19, further comprising analyzing prior encoded blocks of the second subset of prior encoded blocks to identify respective spatial distances of the prior encoded blocks of the second subset of prior encoded blocks in relation to the current block.

21. The method of claim 20, further comprising calculating respective effective distances of the respective prior encoded motion vectors associated with the prior encoded blocks of the second subset of prior encoded blocks as a function of the respective spatial distances of the prior encoded blocks of the second subset of prior encoded blocks, temporal distance between the previous video frame and the current video frame, and respective motion-vector magnitudes of the respective prior encoded motion vectors associated with the prior encoded blocks of the second subset of prior encoded blocks.

22. The method of claim 16, further comprising:
identifying a subset of higher-ordered prior encoded motion vectors from prior encoded motion vectors identified in the specified order, wherein prior encoded motion vectors in the subset of higher-ordered prior encoded motion vectors are higher in order in the specified order than other prior encoded motion vectors associated with the specified order, wherein the specified order is arranged as a function of at least one of respective effective distances of prior encoded motion vectors associated with the specified order or respective frequency of appearance of prior encoded motion vectors in the specified order.

23. The method of claim 22, further comprising:
identifying a first prior encoded motion vector and a second prior encoded motion vector from the subset of higher-ordered prior encoded motion vectors, based at least in part on the specified order; and
selecting one of the first prior encoded motion vector or the second prior encoded motion vector to be the prior encoded motion vector, wherein the first prior encoded motion vector is in a first position in the specified order, and the second prior encoded motion vector is in a second position in the specified order.

24. The method of claim 16, further comprising:
encoding the current block using the prior encoded motion vector to generate an encoded current block; and
transmitting the encoded current block and the coding mode to a destination without transmitting a separate motion vector in relation to transmitting the encoded current block.

25. The method of claim 24, further comprising:
transmitting the encoded current block and the coding mode to the destination, wherein the coding mode indicates that the prior encoded motion vector was used to encode the current block to generate the encoded current block.

26. A system that encodes video frames, comprising:
means for arranging respective prior encoded motion vectors associated with prior encoded blocks of a first subset of prior encoded blocks of a current video frame and a second subset of prior encoded blocks of a previous video frame in a specified order, based at least in part on respective effective distances of the respective prior encoded motion vectors in relation to a current block of the current video frame, wherein the current video frame and the previous video frame are part of a sequence of video frames;
means for identifying a prior encoded motion vector from the respective prior encoded motion vectors associated with the specified order, based at least in part on the specified order;
means for identifying a coding mode based at least in part on rank of the prior encoded motion vector in the specified order;
means for encoding the current block using the prior encoded motion vector to generate an encoded current block; and
means for transmitting the encoded current block and the coding mode to a destination without transmitting a separate motion vector in relation to transmitting the encoded current block.

27. A system that decodes video frames, comprising:
at least one memory that stores computer executable components; and
at least one processor that executes the following computer executable components stored in the at least one memory:
a decoder management component configured to arrange respective motion vectors associated with respective prior decoded blocks of a first subset of prior decoded blocks of a current video frame and a second subset of prior decoded blocks of a previous video frame in a motion vector order based at least in part on respective effective distances of the respective motion vectors in relation to a current block in the current video frame, wherein the current video frame and the previous video frame are part of a sequence of video frames,
wherein the decoder management component is further configured to identify a coding mode associated with the current block, and
wherein the decoder management component is further configured to select a motion vector from the respective motion vectors, based at least in part on the motion vector order and the coding mode; and
a decoder component configured to decode the current block using the motion vector to generate a decoded current block.

28. The system of claim 27, wherein the decoder management component is further configured to arrange the respective motion vectors in the motion vector order as a function of respective spatial distances of the respective prior decoded blocks in relation to the current block, temporal distance between the previous video frame and the current video frame, and respective motion-vector magnitudes of the respective motion vectors.

29. The system of claim 27, further comprising a communicator component configured to receive a coded video bitstream comprising the current video frame, the previous video frame, and the coding mode.

30. The system of claim 27, wherein the first subset of prior decoded blocks comprises prior decoded blocks that are adjacent to the current block in the current video frame, and the second subset of prior decoded blocks comprises prior decoded blocks that are located in positions within the previous video frame that correspond to a location of the current block or locations in the current video frame that are adjacent to the current block.
